(19) United States
(12) Patent Application Publication
(10) Pub. No.: US 2014/0096877 A1
(43) Pub. Date: Apr. 10, 2014

(54) COPPER ALLOY FOR ELECTRONIC DEVICES, METHOD FOR PRODUCING COPPER ALLOY FOR ELECTRONIC DEVICES, COPPER ALLOY PLASTIC WORKING MATERIAL FOR ELECTRONIC DEVICES, AND COMPONENT FOR ELECTRONIC DEVICES

(71) Applicant: MITSUBISHI MATERIALS CORPORATION, Tokyo (JP)

(72) Inventors: Kazunari Maki, Saitama-shi (JP); Yuki Ito, Okegawa-shi (JP)

(73) Assignee: MITSUBISHI MATERIALS CORPORATION, Tokyo (JP)

(21) Appl. No.: 14/119,025

(22) PCT Filed: May 30, 2012
(86) PCT No.: PCT/JP2012/063933

§ 371 Date: Nov. 20, 2013

(30) Foreign Application Priority Data
Jun. 6, 2011 (JP) 2011-126510
Nov. 7, 2011 (JP) 2011-243870

(51) Int. Cl. H01B 1/02

(52) U.S. Cl. CPC H01B 1/026
USPC 148/684; 148/432

(57) ABSTRACT

An aspect of this copper alloy contains: Mg at a content of 3.3 at % or more to less than 6.9 at %; and either one or both of Cr and Zr at respective contents of 0.001 at % to 0.15 at %, with the balance being Cu and inevitable impurities, wherein when the content of Mg is represented by A at %, a conductivity σ (% IACS) satisfies the following Expression (1),

σ≦{1.7241/(−0.0347×A²+0.6569×A+1.7)}×100 (1).

An aspect of this method for producing a copper alloy includes: heating a copper material having the composition of the copper alloy to a temperature of 300° C. to 900° C.; rapidly cooling the heated copper material to a temperature of 200° C. or lower at a cooling rate of 200° C./min or greater; and subjecting the rapidly cooled copper material to working.

### TECHNICAL FIELD

The present invention relates to a copper alloy for electronic devices suitable for components for electronic devices (electronic/electrical components) such as terminals, connectors, relays, and lead frames, a method for producing the copper alloy for electronic devices, a plastically-worked copper alloy material (a copper alloy plastic working material) for electronic devices, and a component for electronic devices.

The present application claims priority on Japanese Patent Application No. 2011-126510 filed on Jun. 6, 2011, and Japanese Patent Application No. 2011-243870 filed on Nov. 7, 2011, the contents of which are incorporated herein by reference.

### BACKGROUND ART

Hitherto, with a decrease in the sizes of electronic devices, electrical devices, and the like, efforts have been made to decrease the sizes and the thicknesses of components for electronic devices such as terminals, connectors, relays, lead frames, and the like which are used in the electronic devices, the electrical devices, and the like. Therefore, there is a demand for a copper alloy which is excellent in terms of spring properties, strength, and conductivity as a material which constitutes components for electronic devices (electronic/electrical components). Particularly, as described in Non-Patent Document 1, it is preferable for a copper alloy which is used in components for electronic devices (electronic/electrical components) such as terminals, connectors, relays, lead frames, and the like to have a high proof stress and a low Young's modulus.

Here, as a copper alloy which is used in components for electronic devices such as terminals, connectors, relays, lead frames, and the like, for example, phosphor bronze containing Sn and P is widely used as shown in Patent Document 1.

In addition, for example, in Patent Document 2, a Cu—Ni—Si-based alloy (so-called Corson alloy) is provided as a copper alloy which is excellent in terms of spring properties, strength, and conductivity. This Corson alloy is a precipitation-hardened alloy in which Ni₂Si precipitates are dispersed, and the Corson alloy has a relatively high conductivity and a relatively high strength, and also has stress relaxation resistance. Therefore, the Corson alloy is frequently used for terminals for vehicles and small terminals for signal systems, and the Corson alloy has been actively developed in recent years.

Furthermore, a Cu—Mg alloy described in Non-Patent Document 2, a Cu—Mg—Zn—B alloy described in Patent Document 3, and the like have been developed as other alloys.

With regard to the Cu—Mg-based alloy, as can be seen from the phase diagram of the Cu—Mg system shown in FIG. 1, in the case where the content of Mg is in a range of 3.3 at % or greater, intermetallic compounds including Cu and Mg can be precipitated by performing a solution treatment (in a range of 500° C. to 900° C.) and a precipitation treatment. That is, even in the Cu—Mg-based alloy, a relatively high conductivity and a relatively high strength can be obtained through precipitation hardening as is the case with the above-described Corson alloy.

However, in the phosphor bronze described in Patent Document 1, the stress-relaxation rate tends to increase at a high temperature. Here, in a connector having a structure in which a male tab pushes up a spring contact portion of a female terminal and is inserted into the female terminal, in the case where the stress-relaxation rate is high at a high temperature, the contact pressure decreases during use under a high-temperature environment; and thereby, there is a concern that energization failure occurs. Therefore, it was not possible to use the phosphor bronze under a high-temperature environment such as the vicinity of an engine room of a vehicle.

In addition, in the Corson alloy disclosed in Patent Document 2, the Young's modulus is in a range of 125 GPa to 135 GPa which is relatively high. Here, in a connector having a structure in which a male tab pushes up a spring contact portion of a female terminal and is inserted into the female terminal, it is not preferable that the Young's modulus of a material constituting the connector be high, because there is a concern that a variation in contact pressure during the insertion is large and the contact pressure easily exceeds an elastic limit, and whereby, plastic deformation occurs.

Furthermore, in the Cu—Mg-based alloys described in Non-Patent Document 2 and Patent Document 3, intermetallic compounds are precipitated as is the case with the Corson alloy. Therefore, the Young's modulus tends to increase; and therefore, these Cu—Mg-based alloys are not preferable for use in a connector as described above.

Furthermore, since a large amount of coarse intermetallic compounds containing Cu and Mg as main components are dispersed in a matrix phase, these intermetallic compounds containing Cu and Mg as main components serve as a starting point of cracking during bending work; and thereby, the cracking easily occurs. Therefore, there is a problem in that it is not possible to mold a component for electronic devices having a complicated shape such as a connector.

### PRIOR ART DOCUMENT

### Patent Documents

Patent Document 1: Japanese Unexamined Patent Application, First Publication No. H01-107943

Patent Document 2: Japanese Unexamined Patent Application, First Publication No. H11-036055

Patent Document 3: Japanese Unexamined Patent Application, First Publication No. H07-018354

### Non-Patent Documents

Non-Patent Document 1: Koya NOMURA, “Technical Trends in High Performance Copper Alloy Strip for Connector and Kobe Steel's Development Strategy”, Kobe Steel Engineering Reports, Vol. 54, No. 1 (2004), p. 2 to 8

Non-Patent Document 2: Shigenori Hori and two others, “Grain Boundary Precipitation in Cu—Mg alloy”, Journal of the Japan Copper and Brass Research Association, Vol. 19 (1980), p. 115 to 124

### DISCLOSURE OF THE INVENTION

### Problems to be Solved by the Invention

The invention is contrived in view of the above-described circumstances, and an object of the invention is to provide a copper alloy for electronic devices which has a low Young's modulus, a high proof stress, high electrical conductivity, and excellent bending workability, and is suitable for electronic/electrical components such as terminals, connectors, and relays, a method for producing the copper alloy for electronic devices, and a plastically-worked copper alloy material for electronic devices.

Another object of the invention is to provide a copper alloy for electronic devices which has a low Young's modulus, a high proof stress, high electrical conductivity, excellent stress relaxation resistance, and excellent bending workability, and is suitable for components for electronic devices such as terminals, connectors, and relays, a method for producing the copper alloy for electronic devices, a plastically-worked copper alloy material for electronic devices, and an electronic device component.

### Means for Solving the Problems

In order to solve the problems, the inventors of the invention have conducted an intensive study and as a result, they found the following knowledge.

(a) A work-hardened copper alloy is produced by adding either one or both of Cr and Zr to a Cu—Mg alloy and by performing solution treatment, working, a heat treatment, and low-temperature annealing. In this work-hardened copper alloy, secondary-phase particles containing either one or both of Cr and Zr are dispersed in a Cu—Mg supersaturated solid solution, and the copper alloy has a low Young's modulus, a high proof stress, high electrical conductivity, and excellent bending workability.

(b) A work-hardened copper alloy of a Cu—Mg supersaturated solid solution is produced by rapidly cooling a Cu—Mg alloy after solution treatment. This work-hardened copper alloy has a low Young's modulus, a high proof stress, high electrical conductivity, and excellent bending workability. In addition, by subjecting this copper alloy of the Cu—Mg supersaturated solid solution to an appropriate heat treatment after a finish working, stress relaxation resistance can be improved. Furthermore, by adding appropriate amounts of Cr and Zr, the size of crystal grains can be decreased and the strength can be improved.

The invention is contrived based on such knowledge, and has the following features.

(1) A copper alloy for electronic devices which contains: Mg at a content of 3.3 at % or more to less than 6.9 at %; and either one or both of Cr and Zr at respective contents of 0.001 at % to 0.15 at %, with the balance being Cu and inevitable impurities, wherein when the content of Mg is represented by A at %, a conductivity σ (% IACS) satisfies the following Expression (1),

σ≦{1.7241/(−0.0347×A²+0.6569×A+1.7)}×100 (1).

(2) The copper alloy for electronic devices according to (1), wherein a Young's modulus E is in a range of 125 GPa or less, and a 0.2% proof stress σ_{0.2} is in a range of 400 MPa or greater.

(3) The copper alloy for electronic devices according to (1) or (2), wherein an average crystal grain size is in a range of 20 μm or less.

(4) A method for producing a copper alloy for electronic devices which includes: heating a copper material containing: Mg at a content of 3.3 at % or more to less than 6.9 at %; and either one or both of Cr and Zr at respective contents of 0.001 at % to 0.15 at %, with the balance being Cu and inevitable impurities, to a temperature of 300° C. to 900° C.; rapidly cooling the heated copper material to a temperature of 200° C. or lower at a cooling rate of 200° C./min or greater; and subjecting the rapidly cooled copper material to working, wherein the copper alloy for electronic devices according to any one of (1) to (3) is produced.

(5) A plastically-worked copper alloy material for electronic devices which includes the copper alloy for electronic devices according to any one of (1) to (3), wherein a Young's modulus E in a rolling direction is in a range of 125 GPa or less, and a 0.2% proof stress σ_{0.2} in the rolling direction is in a range of 400 MPa or greater.

(6) The plastically-worked copper alloy material for electronic devices according to (5) which is used as a copper material constituting a terminal, a connector, or a relay.

In the above-described copper alloy for electronic devices according to the aspect (1), Mg is contained at a content of 3.3 at % or more to less than 6.9 at % which is not less than a solid solution limit, and when the content of Mg is represented by A at %, the conductivity σ is set to be in the range of the above-described Expression (1). Therefore, the copper alloy for electronic devices is a Cu—Mg supersaturated solid solution in which Mg is solid-solubilized in a matrix phase.

In the copper alloy including this Cu—Mg supersaturated solid solution, there is a tendency that the Young's modulus becomes low. For example, when the copper alloy is applied to a connector having a structure in which a male tab pushes up a spring contact portion of a female terminal and is inserted into the female terminal, a variation in contact pressure during the insertion is suppressed. In addition, since an elastic limit is high, there is no concern that plastic deformation easily occurs. Therefore, the copper alloy for electronic devices according to the aspect (1) is particularly suitable for electronic/electrical components such as terminals, connectors, relays, and the like.

Furthermore, since Mg is solid-solubilized in a supersaturated manner, the strength can be improved by work hardening.

In addition, a large amount of coarse intermetallic compounds containing Cu and Mg as main components, which serve as a starting point of cracking, are not dispersed in a matrix phase; and thereby, the bending workability is improved. Therefore, it is possible to mold electronic/electrical components having a complicated shape such as terminals, connectors, relays, and the like.

Furthermore, in the copper alloy for electronic devices according to the aspect (1), either one or both of Cr and Zr are contained at respective contents of 0.001 at % to 0.15 at %. Therefore, crystal grains are refined, and the workability and the strength can be improved.

In addition, since Cr and Zr are precipitated as dispersed particles containing Cr and Zr in the matrix phase, it is possible to improve the strength without decreasing the conductivity. In the case where Cr and Zr are contained at contents within the above-described range, the dispersed particles containing Cr and Zr are very small or are present in a small amount; and therefore, there is no concern that the bending workability is adversely affected.

Here, in the above-described copper alloy for electronic devices, a Young's modulus E is preferably in a range of 125 GPa or less, and a 0.2% proof stress σ_{0.2} is preferably in a range of 400 MPa or greater as in the aspect (2).

In the case where the Young's modulus E is in a range of 125 GPa or less and the 0.2% proof stress σ_{0.2} is in a range of 400 MPa or greater, a resilience modulus (σ_{0.2}²/2E) is high; and therefore, plastic deformation does not easily occur. As a result, the copper alloy for electronic devices according to the aspect (2) is particularly suitable for electronic/electrical components such as terminals, connectors, relays, and the like.

Furthermore, in the above-described copper alloy for electronic devices, an average crystal grain size is preferably in a range of 20 μm or less as in the aspect (3). The 0.2% proof stress σ_{0.2} can be further increased by adjusting the average crystal grain size to be in a range of 20 μm or less.

The method for producing a copper alloy for electronic devices according to the aspect (4) is a method for producing the above-described copper alloy for electronic devices according to any one of the aspects (1) to (3). This production method includes: heating a copper material to a temperature of 300° C. to 900° C.; rapidly cooling the heated copper material to a temperature of 200° C. or lower at a cooling rate of 200° C./min or greater; and subjecting the rapidly cooled copper material to working. The copper material contains Mg at a content of 3.3 at % or more to less than 6.9 at %, and either one or both of Cr and Zr at respective contents of 0.001 at % to 0.15 at %, with the balance being Cu and inevitable impurities.

According to the method for producing a copper alloy for electronic devices according to the aspect (4), the solution treatment of Mg can be performed by the heating process of heating a copper material having the above-described composition to a temperature of 300° C. to 900° C. Here, in the case where the heating temperature is in a range of lower than 300° C., the solution treatment is incompletely performed; and thereby, there is a concern that a large amount of intermetallic compounds containing Cu and Mg as main components remain in the matrix phase. On the other hand, in the case where the heating temperature is in a range of higher than 900° C., a part of the copper material becomes a liquid phase; and thereby, there is a concern that the microstructure or the surface state becomes uneven. Therefore, the heating temperature is set to be in a range of 300° C. to 900° C. In order to reliably exhibit such effects, the heating temperature in the heating process is preferably set to be in a range of 500° C. to 800° C.

In addition, since the rapid cooling process of cooling the heated copper material to a temperature of 200° C. or lower at a cooling rate of 200° C./min or greater is provided, it is possible to suppress the precipitation of intermetallic compounds containing Cu and Mg as main components in the course of cooling. Accordingly, the copper material can be formed into a Cu—Mg supersaturated solid solution.

Furthermore, since the working process of subjecting the rapidly cooled copper material (Cu—Mg supersaturated solid solution) to working is provided, the strength can be improved by work hardening. Here, the working method is not particularly limited. For example, rolling is employed in the case where the final form is a plate or a strip. Wire drawing, extrusion, or groove rolling is employed in the case where the final form is a line or a rod. Forging or pressing is employed in the case where the final form is a bulk shape. The working temperature is also not particularly limited. However, it is preferable to set the working temperature to be in a range of −200° C. to 200° C. to perform cold or warm working; and thereby, the precipitation is prevented. The working rate is appropriately selected so as to obtain a shape close to the final shape. The working rate is preferably in a range of 20% or greater, and more preferably in a range of 30% or greater in consideration of work hardening.

So-called low-temperature annealing may be performed after the working process. It is possible to further improve the mechanical characteristics by the low-temperature annealing.

The plastically-worked copper alloy material for electronic devices according to the aspect (5) includes the above-described copper alloy for electronic devices according to any one of the aspects (1) to (3), and a Young's modulus E is in a range of 125 GPa or less and a 0.2% proof stress σ_{0.2} is in a range of 400 MPa or greater.

According to the plastically-worked copper alloy material for electronic devices according to the aspect (5), a resilience modulus (σ_{0.2}²/2E) is high; and therefore, plastic deformation does not easily occur.

In addition, the above-described plastically-worked copper alloy material for electronic devices is preferably used as a copper material constituting a terminal, a connector, or a relay as in the aspect (6).

(7) A copper alloy for electronic devices which contains: Mg at a content of 3.3 at % to 6.9 at %; and either one or both of Cr and Zr at respective contents of 0.001 at % to 0.15 at %, with the balance being substantially Cu and inevitable impurities, wherein when the content of Mg is represented by X at %, a conductivity σ (% IACS) satisfies the following Expression (2), and a stress-relaxation rate after 1,000 hours at 150° C. is in a range of 50% or less,

σ≦{1.7241/(−0.0347×X²+0.6569×X+1.7)}×100 (2).

(8) A copper alloy for electronic devices which contains: Mg at a content of 3.3 at % to 6.9 at %; and either one or both of Cr and Zr at respective contents of 0.001 at % to 0.15 at %, with the balance being substantially Cu and inevitable impurities, wherein an average number of grains of intermetallic compounds containing Cu and Mg as main components and having grain sizes of 0.1 μm or greater, which are observed by a scanning electron microscope, is in a range of 1/μm² or less, and a stress-relaxation rate after 1,000 hours at 150° C. is in a range of 50% or less.

(9) A copper alloy for electronic devices which contains: Mg at a content of 3.3 at % to 6.9 at %; and either one or both of Cr and Zr at respective contents of 0.001 at % to 0.15 at %, with the balance being substantially Cu and inevitable impurities, wherein when the content of Mg is represented by X at %, a conductivity σ (% IACS) satisfies the following Expression (2), an average number of grains of intermetallic compounds containing Cu and Mg as main components and having grain sizes of 0.1 μm or greater, which are observed by a scanning electron microscope, is in a range of 1/μm² or less, and a stress-relaxation rate after 1,000 hours at 150° C. is in a range of 50% or less,

σ≦{1.7241/(−0.0347×X²+0.6569×X+1.7)}×100 (2).

(10) The copper alloy for electronic devices according to any one of (7) to (9), wherein a Young's modulus is in a range of 125 GPa or less, and a 0.2% proof stress σ_{0.2} is in a range of 400 MPa or greater.

(11) A method for producing a copper alloy for electronic devices which includes: subjecting a copper material having a composition that contains: Mg at a content of 3.3 at % to 6.9 at %; and either one or both of Cr and Zr at respective contents of 0.001 at % to 0.15 at %, with the balance being substantially Cu and inevitable impurities, to finish rolling to roll the copper material into a predetermined shape; and performing a finish heat treatment to perform a heat treatment after the finish rolling, wherein the copper alloy for electronic devices according to any one of (7) to (10) is produced.

(12) The method for producing a copper alloy for electronic devices according to (11), wherein in the finish heat treatment, the heat treatment is performed at a temperature in a range of higher than 200° C. to 800° C. or lower, and then, the heated copper material is cooled to a temperature of 200° C. or lower at a cooling rate of 200° C./min or greater.

(13) A plastically-worked copper alloy material for electronic devices which includes the copper alloy for electronic devices according to any one of (7) to (10), wherein a Young's modulus E in a direction parallel to a rolling direction is in a range of 125 GPa or less, and a 0.2% proof stress σ_{0.2} in the direction parallel to the rolling direction is in a range of 400 MPa or greater.

(14) A plastically-worked copper alloy material for electronic devices which includes the copper alloy for electronic devices according to any one of (7) to (10), wherein the plastically-worked copper alloy material is used as a copper material constituting a component for electronic devices which is a terminal, a connector, a relay, or a lead frame.

(15) A component for electronic devices which is formed of the copper alloy for electronic devices according to any one of (7) to (10).

In the above-described copper alloy for electronic devices according to the aspect (7) or (9), Mg is contained at a content of 3.3 at % to 6.9 at % which is not less than a solid solution limit, and when the content of Mg is represented by X at %, the conductivity σ is set to be in the range of the above-described Expression (2). Therefore, the copper alloy for electronic devices is a Cu—Mg supersaturated solid solution in which Mg is solid-solubilized in a matrix phase.

In the above-described copper alloy for electronic devices according to the aspect (8) or (9), Mg is contained in a range of 3.3 at % to 6.9 at % which is not less than a solid solution limit, and an average number of grains of intermetallic compounds containing Cu and Mg as main components and having grain sizes of 0.1 μm or greater, which are observed by a scanning electron microscope, is in a range of 1/μm² or less. Therefore, the precipitation of the intermetallic compounds containing Cu and Mg as main components is suppressed, and the copper alloy for electronic devices is a Cu—Mg supersaturated solid solution in which Mg is solid-solubilized in a matrix phase.

The average number of grains of the intermetallic compounds containing Cu and MG as main components and having grain sizes of 0.1 μm or greater is calculated by observing 10 visual fields by using a field emission scanning electron microscope at 50,000-fold magnification under the condition in which the visual field is approximately 4.8 μm².

In addition, an average value of the long diameter and the short diameter of a grain of the intermetallic compound is set as the grain size of the intermetallic compound containing Cu and Mg as main components. The long diameter is a length of the longest straight line in a grain which does not come into contact with a grain boundary on the way, and the short diameter is a length of the longest straight line in a direction orthogonal to the long diameter which does not come into contact with the grain boundary on the way.

In the copper alloy including this Cu—Mg supersaturated solid solution, there is a tendency that the Young's modulus becomes low. For example, when the copper alloy is applied to a connector having a structure in which a male tab pushes up a spring contact portion of a female terminal and is inserted into the female terminal, a variation in contact pressure during the insertion is suppressed. In addition, since an elastic limit is high, there is no concern that plastic deformation easily occurs. Therefore, the copper alloy for electronic devices according to the aspects (7) to (9) is particularly suitable for components for electronic devices such as terminals, connectors, relays, lead frames, and the like.

In addition, since Mg is solid-solubilized in a supersaturated manner, a large amount of coarse intermetallic compounds containing Cu and Mg as main components, which serve as a starting point of cracking, are not dispersed in a matrix phase; and thereby, the bending workability is improved. Therefore, it is possible to mold components for electronic devices having a complicated shape such as terminals, connectors, relays, lead frames, and the like.

Furthermore, since Mg is solid-solubilized in a supersaturated manner, the strength can be improved by work hardening.

In the copper alloy for electronic devices according to the aspects (7) to (9), either one or both of Cr and Zr are contained at respective contents of 0.001 at % to 0.15 at %, respectively. Therefore, the size of crystal grains are decreased, and it is possible to improve the mechanical strength without greatly decreasing the conductivity.

In the copper alloy for electronic devices according to the aspects (7) to (9), the stress-relaxation rate after 1,000 hours at 150° C. is in a range of 50% or less. Therefore, even during use under a high-temperature environment, it is possible to suppress the occurrence of energization failure due to a decrease in the contact pressure. Therefore, the copper alloy for electronic devices according to the aspects (7) to (9) can be applied as a material of a component for electronic devices which is used under a high-temperature environment such as an engine room and the like.

Here, in the above-described copper alloy for electronic devices, a Young's modulus E is preferably in a range of preferably 125 GPa or less, and a 0.2% proof stress σ_{0.2} is preferably in a range of 400 MPa or greater as in the aspect (10).

In the case where the Young's modulus E is in a range of 125 GPa or less and the 0.2% proof stress σ_{0.2} is in a range of 400 MPa or greater, a resilience modulus (σ_{0.2}²/2E) is high; and therefore, plastic deformation does not easily occur. As a result, the copper alloy for electronic devices according to the aspect (10) is particularly suitable for components for electronic devices such as terminals, connectors, relays, lead frames, and the like.

The method for producing a copper alloy for electronic devices according to the aspect (11) is a method for producing a copper alloy for electronic devices to produce the copper alloy for electronic devices according to any one of the aspects (7) to (9). This production method includes: subjecting a copper material to finish rolling to roll the copper material into a predetermined shape; and performing a finish heat treatment to perform a heat treatment after the finish rolling step. The copper material contains Mg at a content of 3.3 at % to 6.9 at %, either one or both of Cr and Zr at respective contents of 0.001 at % to 0.15 at %, with the balance being substantially Cu and inevitable impurities.

According to the method for producing a copper alloy for electronic devices according to the aspect (11), since the finish working process of subjecting a copper material having the above-described composition to working into a predetermined shape and the finish heat treatment process of performing a heat treatment after the finish working process are provided, stress relaxation resistance can be improved by the finish heat treatment process.

Here, in the finish heat treatment process, the heat treatment is preferably performed at a temperature of higher than 200° C. to 800° C. or lower as in the aspect (12). Furthermore, the heated copper material is preferably cooled to a temperature of 200° C. or lower at a cooling rate of 200° C./min or greater.

In this case, the stress relaxation resistance can be improved by the finish heat treatment process, and the stress-relaxation rate after 1,000 hours at 150° C. can be adjusted to be in a range of 50% or less.

The plastically-worked copper alloy material for electronic devices according to the aspect (13) includes the copper alloy for electronic devices according to any one of the aspects (7) to (10), and a Young's modulus E is in a range of 125 GPa or less in a direction parallel to a rolling direction, and a 0.2% proof stress σ_{0.2} is in a range of 400 MPa or greater in the direction parallel to the rolling direction.

According to the plastically-worked copper alloy material for electronic devices according to the aspect (13), a resilience modulus (σ_{0.2}²/2E) is high; and therefore, plastic deformation does not easily occur.

In this specification, the plastically-worked material is a copper alloy subjected to plastic working in any manufacturing process.

In addition, the above-described plastically-worked copper alloy material for electronic devices is preferably used as a copper material constituting a component for electronic devices such as a terminal, a connector, a relay, or a lead frame.

Furthermore, the component for electronic devices according to the aspect (15) is formed of the copper alloy for electronic devices according to any one of the aspects (7) to (10).

Since this component for electronic devices according to the aspect (15) (for example, terminal, connector, relay, or lead frame) has a low Young's modulus and excellent stress relaxation resistance, it can be used even under a high-temperature environment.

### Effects of the Invention

According to an aspect of the invention, it is possible to provide a copper alloy for electronic devices which has a low Young's modulus, a high proof stress, high electrical conductivity, and excellent bending workability, and is suitable for electronic/electrical components such as terminals, connectors, relays, and the like, a method for producing the copper alloy for electronic devices, and a plastically-worked copper alloy material for electronic devices.

According to an aspect of the invention, it is possible to provide a copper alloy for electronic devices which has a low Young's modulus, a high proof stress, high electrical conductivity, excellent stress relaxation resistance, and excellent bending workability, and is suitable for components for electronic devices such as terminals, connectors, and relays, a method for producing the copper alloy for electronic devices, a plastically-worked copper alloy material for electronic devices, and a component for electronic devices.

### BRIEF DESCRIPTION OF THE DRAWINGS

FIG. 1 is a phase diagram of a Cu—Mg system.

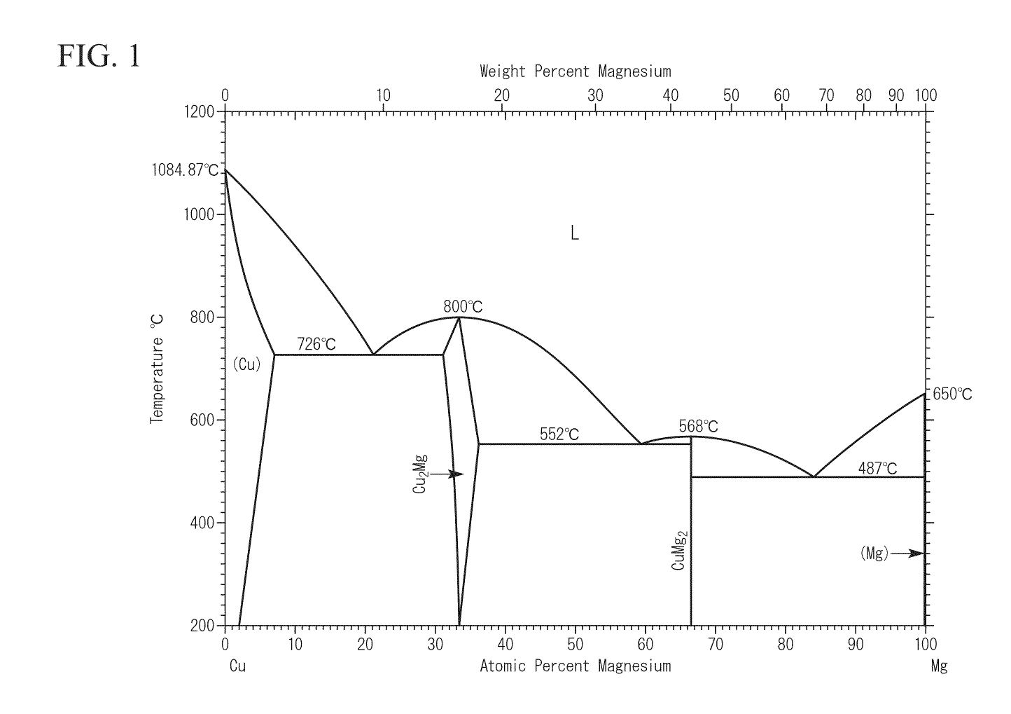

FIG. 2 is a flow diagram of a method for producing a copper alloy for electronic devices of a first embodiment.

FIG. 3 is a flow diagram of a method for producing a copper alloy for electronic devices of a second embodiment.

FIG. 4 shows analysis results of Invention Example 1-3, in which (a) is a SEM photograph, (b) is a distribution diagram of Cr in the observation visual field of (a), and (c) shows results of a qualitative analysis by EDX.

FIG. 5 shows analysis results of Invention Example 1-10, in which (a) is a SEM photograph, (b) is a distribution diagram of Zr in the observation visual field of (a), and (c) shows results of a qualitative analysis by EDX.

FIG. 6 shows results of a precipitate analysis of Invention Example 2-3, in which (a) is a SEM photograph, (b) is a distribution diagram of Mg in the observation visual field of (a), (c) is a distribution diagram of Cr in the observation visual field of (a), and (d) shows results of a qualitative analysis by EDX.

FIG. 7 shows results of a precipitate analysis of Invention Example 2-8, in which (a) is a SEM photograph, (b) is a distribution diagram of Mg in the observation visual field of (a), (c) is a distribution diagram of Zr in the observation visual field of (a), and (d) shows results of a qualitative analysis by EDX.

### BEST MODE FOR CARRYING OUT THE INVENTION

Hereinafter, a copper alloy for electronic devices, a method for producing the same, a plastically-worked copper alloy material for electronic devices, and a component for electronic devices, according to an embodiment of the invention will be described.

### First Embodiment

A copper alloy for electronic devices according to this embodiment contains Mg at a content of 3.3 at % or more to less than 6.9 at %, and either one or both of Cr and Zr at respective contents of 0.001 at % to 0.15 at %, with the balance being Cu and inevitable impurities.

When the content of Mg is represented by A at %, a conductivity σ (% IACS) satisfies the following Expression (1).

σ≦{1.7241/(−0.0347×A²+0.6569×A+1.7)}×100 (1)

In addition, this copper alloy for electronic devices has a Young's modulus E of 125 GPa or less and a 0.2% proof stress σ_{0.2} of 400 MPa or greater.

### (Composition)

Mg is an element having effects of improving a strength and raising a recrystallization temperature without greatly decreasing a conductivity. In addition, in the case where Mg is solid-solubilized in a matrix phase, the Young's modulus is suppressed to be low, and excellent bending workability is obtained.

Here, in the case where the content of Mg is in a range of less than 3.3 at %, the effects cannot be exhibited. On the other hand, in the case where the content of Mg is in a range of 6.9 at % or more, intermetallic compounds containing Cu and Mg as main components remain when a heat treatment for solution treatment is performed. Therefore, there is a concern that cracking occurs during subsequent working or the like.

For these reasons, the content of Mg is set to be in a range of 3.3 at % or more to less than 6.9 at %.

Furthermore, in the case where the content of Mg is small, the strength is not sufficiently improved, and the Young's modulus cannot be suppressed to be sufficiently low. In addition, Mg is an active element. Therefore, in the case where an excessive amount of Mg is contained, there is a concern that Mg oxides which are generated by reactions with oxygen during melting and casting are mixed (contained). Accordingly, the content of Mg is more preferably set to be in a range of 3.7 at % to 6.3 at %.

Cr and Zr are elements having an effect of easily decreasing the size of crystal grains after an intermediate heat treatment. It is presumed that this is due to the fact that secondary-phase particles containing Cr and Zr are dispersed in a matrix phase and have an effect of suppressing the growth of crystal grains of the matrix phase during a heat treatment. This crystal grain refining effect is more remarkably exhibited by repeating the intermediate working and the intermediate heat treatment. In addition, due to the dispersion of such fine secondary-phase particles and the refinement of crystal grains, the strength is further improved without a great decrease in the conductivity.

Here, in the case where the content of Cr and the content of Zr are in a range of less than 0.001 at %, respectively, the effect cannot be exhibited. On the other hand, in the case where the content of Cr and the content of Zr are in a range of more than 0.15 at %, respectively, there is a concern that cracked edges are caused during rolling.

For these reasons, the content of Cr and the content of Zr are set to be in a range of 0.001 at % to 0.15 at %, respectively.

Furthermore, in the case where the content of Cr and the content of Zr are small, there is a concern that the effect of improving the strength and the effect of refining the crystal grains cannot be reliably exhibited. In addition, in the case where the content of Cr and the content of Zr are large, ease of rolling and bending workability are adversely affected.

Accordingly, the content of Cr and the content of Zr are more preferably set to be in a range of 0.005 at % to 0.12 at %, respectively.

Examples of the inevitable impurities include Zn, Sn, Fe, Co, Al, Ag, Mn, B, P, Ca, Sr, Ba, Sc, Y, rare-earth elements, Hf, V, Nb, Ta, Mo, W, Re, Ru, Os, Se, Te, Rh, Ir, Pd, Pt, Au, Cd, Ga, In, Li, Si, Ge, As, Sb, Ti, Tl, Pb, Bi, S, O, C, Ni, Be, N, H, and Hg. These inevitable impurities are preferably contained in a total amount of 0.3% by mass or less.

### (Conductivity σ)

In the copper alloy having the above-described composition, in the case where the conductivity σ (% IACS) satisfies the following Expression (1) when the content of Mg is represented by A at %, there are very few intermetallic compounds containing Cu and Mg as main components.

σ≦{1.7241/(−0.0347×A²+0.6569×A+1.7)}×100 (1)

That is, in the case where the conductivity σ is in a range of greater than the value on the right side of the above-described Expression (1), a large amount of intermetallic compounds containing Cu and Mg as main components are present, and furthermore, the sizes thereof are relatively large. Therefore, the bending workability greatly deteriorates. In addition, due to the generation of the intermetallic compounds containing Cu and Mg as main components, an amount of solid-solubilized Mg becomes small. Therefore, the Young's modulus is also increased. Therefore, in the case where production conditions are adjusted so that the conductivity σ satisfies the above-described Expression (1), the Young's modulus can be suppressed to be low, and workability can be improved.

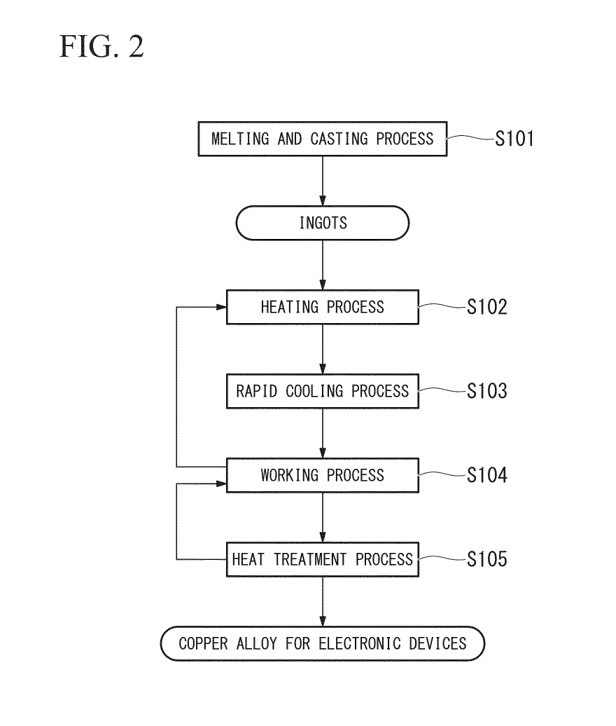

Next, a method for producing the copper alloy for electronic devices according to this embodiment will be described with reference to the flow diagram shown in FIG. 2.

### (Melting and Casting Process S101)

First, a copper raw material is melted to obtain molten copper. Then, the above-described elements are added to the obtained molten copper so as to adjust components; and thereby, a molten copper alloy is produced. In the addition of Mg, Cr, and Zr, single elements of Mg, Cr, and Zr, master alloys thereof, or the like can be used. In addition, a raw material containing Mg, Cr, and Zr may be melted together with the copper raw material. In addition, a recycled material and a scrapped material of the copper alloy may be used.

Here, it is preferable that the molten copper be copper having a purity of 99.99% by mass or greater, i.e., so-called 4NCu. In addition, in the melting process, it is preferable to use a vacuum furnace, and more preferable to use an atmosphere furnace having an inert gas atmosphere or a reducing atmosphere so as to suppress oxidization of Mg, Cr, and Zr.

The molten copper alloy in which the components are adjusted is injected into a mold to produce copper alloy (copper material) ingots. A continuous casting method or a semi-continuous casting method is preferably used in consideration of mass production.

### (Heating Process S102)

Next, a heating treatment is performed for homogenization and solution treatment of the obtained ingots. In the course of solidification, Mg segregates and concentrates; and thereby, intermetallic compounds and the like containing Cu and Mg as main components are generated. In the interior of the ingots, the intermetallic compounds and the like containing Cu and Mg as main components are present. Therefore, in order to eliminate or reduce the segregation and the intermetallic compounds and the like, the ingots are subjected to a heating treatment to heat the ingots to a temperature of 300° C. to 900° C. Thereby, Mg is homogeneously diffused or Mg is solid-solubilized in a matrix phase in the ingots. It is preferable that the heating process S102 be performed in a non-oxidization atmosphere or a reducing atmosphere.

### (Rapid Cooling Process S103)

Then, the ingots heated to a temperature of 300° C. to 900° C. in the heating process S102 are cooled to a temperature of 200° C. or lower at a cooling rate of 200° C./min or greater. Due to this rapid cooling process S103, the Mg solid-solubilized in the matrix phase is suppressed from being precipitated as intermetallic compounds.

In order to increase the efficiency of rough working and the uniformity of the microstructure, hot working may be performed after the above-described heating process S102 and the above-described rapid cooling process S103 may be performed after this hot working. In this case, the hot working method is not particularly limited. For example, rolling can be employed in the case where the final form is a plate or a strip. Wire drawing, extrusion, groove rolling, or the like can be employed in the case where the final form is a line or a rod. Forging or pressing can be employed in the case where the final form is a bulk shape.

### (Working Process S104)

The ingots subjected to the heating process S102 and the rapid cooling process S103 are cut as necessary. In addition, surface grinding is performed as necessary in order to remove an oxide film and the like generated by the heating process S102, the rapid cooling process S103, and the like. Then, the ingots are subjected to working to have a predetermined shape.

Here, the working method is not particularly limited. For example, rolling can be employed in the case where the final form is a plate or a strip. Wire drawing, extrusion, or groove rolling can be employed in the case where the final form is a line or a rod. Forging or pressing can be employed in the case where the final form is a bulk shape.

A temperature condition in the working process S104 is not particularly limited. However, it is preferable to set the working temperature to be in a range of −200° C. to 200° C. to perform cold or warm working; and thereby, the precipitation is prevented.

In addition, a working rate is appropriately selected so as to obtain a shape close to the final shape. In order to improve a strength by work hardening, the working rate is preferably set to be in a range of 20% or greater. In addition, the working rate is more preferably set to be in a range of 30% or greater to further improve the strength.

Furthermore, as shown in FIG. 2, the above-described heating process S102, rapid cooling process S103, and working process S104 may be repeatedly performed. Here, the heating process S102 after one cycle is performed so as to conduct complete solution treatment, to obtain a recrystallized microstructure, to refine crystal grains, to precipitate secondary-phase particles containing Cr and Zr, and to cause softening for improvement in workability. In addition, instead of the ingots, a worked material becomes an object.

### (Heat Treatment Process S105)

Next, the worked material obtained by the working process S104 is subjected to a heat treatment so as to cause hardening by low-temperature annealing and to improve the stress relaxation resistance. Conditions of this heat treatment are appropriately set according to characteristics which are required for a product to be produced.

In this heat treatment process S105, it is necessary to set the heat treatment conditions (temperature, time, and cooling rate) so that the solid-solubilized Mg does not precipitate. For example, this heat treatment process is preferably performed at 200° C. for approximately 1 minute to 1 hour, at 300° C. for approximately 1 second to 5 minutes, or at 350° C. for approximately 1 second to 3 minutes. The cooling rate is preferably set to be in a range of 200° C./min or greater.

In addition, the heat treatment method is not particularly limited, but it is preferable to perform the heat treatment at a temperature of 100° C. to 500° C. for 0.1 second to 24 hours in a non-oxidization atmosphere or a reducing atmosphere. In addition, the cooling method is not particularly limited, but it is preferable to employ a method such as water quenching in which a cooling rate is in a range of 200° C./min or greater.

Furthermore, the above-described working process S104 and heat treatment process S105 may be repeatedly performed.

In this manner, the copper alloy for electronic devices according to this embodiment is produced. The copper alloy for electronic devices according to this embodiment has a Young's modulus E of 125 GPa or less and a 0.2% proof stress σ_{0.2} of 400 MPa or greater.

In addition, when the content of Mg is represented by A at %, a conductivity σ (% IACS) satisfies the following Expression (1):

σ≦{1.7241/(−0.0347×A²+0.6569×A+1.7)}×100 (1)

According to the copper alloy for electronic devices according to this embodiment, Mg is contained at a content of 3.3 at % or more to less than 6.9 at %, and one or more of Cr and Zr are contained at respective contents of 0.001 at % to 0.15 at %, with the balance being Cu and inevitable impurities. In addition, when the content of Mg is represented by A at %, a conductivity σ (% IACS) satisfies the following Expression (1):

σ≦∴1.7241/(−0.0347×A²+0.6569×A+1.7)}×100 (1)

That is, the copper alloy for electronic devices according to this embodiment is a Cu—Mg supersaturated solid solution in which Mg is solid-solubilized in a matrix phase.

In the copper alloy including the Cu—Mg supersaturated solid solution, there is a tendency that the Young's modulus becomes low. For example, when the copper alloy is applied to a connector having a structure in which a male tab pushes up a spring contact portion of a female terminal and is inserted into the female terminal, a variation in contact pressure during the insertion is suppressed. Furthermore, since an elastic limit is high, there is no concern that plastic deformation easily occurs. Therefore, the copper alloy is particularly suitable for electronic/electrical components such as terminals, connectors, and relays.

In addition, since Mg is solid-solubilized in a supersaturated manner, a large amount of coarse intermetallic compounds containing Cu and Mg as main components, which serve as a starting point of cracking during a bending process, are not dispersed in a matrix phase; and thereby, the bending workability is improved. Therefore, it is possible to mold terminals, connectors, and the like having a complicated shape.

Furthermore, since Mg is solid-solubilized in a supersaturated manner, the strength is improved by work hardening; and thereby, the copper alloy has a relatively high strength.

In addition, since the copper alloy in which Mg is solid-solubilized further contains either one or both of Cr and Zr, it is possible to refine crystal grains and improve workability.

Furthermore, by dispersing secondary-phase particles containing these Cr and Zr, it is possible to further improve the strength without decreasing the conductivity.

Since the copper alloy for electronic devices has a Young's modulus of 125 GPa or less and a 0.2% proof stress σ_{0.2} of 400 MPa or greater, a resilience modulus (σ_{0.2}²/2E) is high; and therefore, plastic deformation does not easily occur. Accordingly, the copper alloy for electronic devices is particularly suitable for terminals, connectors, and the like.

In addition, the 0.2% proof stress σ_{0.2} can be increased by adjusting the average crystal grain size to be in a range of 20 μm or less.

In addition, according to the method for producing the copper alloy for electronic devices according to this embodiment, the ingot or the worked material, which is a copper alloy (copper material) having the above-described composition containing Cu, Mg, and one or more of Cr and Zr, is heated to a temperature of 300° C. to 900° C. in the heating process S102. The solution treatment of Mg can be performed by the heating process S102.

In addition, in the rapid cooling process S103, the ingot or the worked material heated to a temperature of 300° C. to 900° C. by the heating process S102 is cooled to a temperature of 200° C. or lower at a cooling rate of 200° C./min or greater. Since this rapid cooling process S103 is provided, it is possible to suppress the precipitation of intermetallic compounds containing Cu and Mg as main components in the course of cooling. Accordingly, the ingot or the worked material after the rapid cooling can be formed as a Cu—Mg supersaturated solid solution.

Furthermore, since the working process S104 is provided to subject the rapidly cooled material to working, the strength can be improved by work hardening.

In addition, after the working process S104, the heat treatment process S105 is performed so as to cause hardening by low-temperature annealing or to remove residual strains, and to improve the stress relaxation resistance. Therefore, it is possible to further improve the mechanical characteristics.

As described above, according to the copper alloy for electronic devices according to this embodiment, it is possible to provide a copper alloy for electronic devices which has a low Young's modulus, a high proof stress, high electrical conductivity, and excellent bending workability, and is suitable for electronic/electrical components such as terminals, connectors, relays, and the like.

### (Plastically-Worked Copper Alloy Material for Electronic Devices)

A plastically-worked copper alloy material for electronic devices according to this embodiment includes the above-described copper alloy for electronic devices according to this embodiment. A Young's modulus E is in a range of 125 GPa or less, and a 0.2% proof stress σ_{0.2} is in a range of 400 MPa or greater. Since a resilience modulus (σ_{0.2}²/2E) is high, plastic deformation does not easily occur. Therefore, the plastically-worked copper alloy material is used as a copper material which constitutes terminals, connectors, and relays. The plastic working method is not particularly limited. However, rolling is preferably employed in the case where the final shape is a plate or a strip. Extrusion or groove rolling is preferably employed in the case where the final shape is a line or a rod. Forging or pressing is preferably employed in the case where the final shape is a bulk shape.

The copper alloy for electronic devices, the method for producing the copper alloy for electronic devices, and the plastically-worked copper alloy material for electronic devices according to the first embodiment of the invention have been described. However, the invention is not limited thereto, and it is possible to make appropriate changes without departing from the features of the invention.

For example, in the above-described embodiment, an example of the method for producing the copper alloy for electronic devices has been described, but the producing method is not limited to this embodiment, and a known producing method may be appropriately selected to produce the copper alloy.

### Second Embodiment

A copper alloy for electronic devices according to this embodiment has a component composition including Mg at a content of 3.3 at % to 6.9 at % and either one or both of Cr and Zr at respective contents of 0.001 at % to 0.15 at %, with the balance being Cu and inevitable impurities.

When the content of Mg is represented by X at %, a conductivity σ (% IACS) satisfies the following Expression (2):

σ≦{1.7241/(−0.0347×X²+0.6569×X+1.7)}×100 (2)

In addition, an average number of grains of intermetallic compounds containing Cu and Mg as main components and having grain sizes of 0.1 μm or greater, which are observed by a scanning electron microscope, is in a range of 1/μm² or less.

The stress-relaxation rate after 1,000 hours at 150° C. is in a range of 50% or less. Here, the stress-relaxation rate is measured by applying a stress with the method according to the cantilever screw-type based on the Japan Copper and Brass Association Technical Standards JCBA-T309: 2004.

In addition, the copper alloy for electronic devices have a Young's modulus of 125 GPa or less and a 0.2% proof stress σ_{0.2} of 400 MPa or greater.

### (Composition)

Mg is an element having effects of improving a strength and raising a recrystallization temperature without greatly decreasing a conductivity. In addition, in the case where Mg is solid-solubilized in a matrix phase, the Young's modulus is suppressed to be low, and excellent bending workability is obtained.

Here, in the case where the content of Mg is in a range of less than 3.3 at %, the effects cannot be exhibited. On the other hand, in the case where the content of Mg is in a range of more than 6.9 at %, intermetallic compounds containing Cu and Mg as main components remain when a heat treatment for solution treatment is performed. Therefore, there is a concern that cracking occurs during subsequent working or the like.

For these reasons, the content of Mg is set to be in a range of 3.3 at % to 6.9 at %.

Furthermore, in the case where the content of Mg is small, the strength is not sufficiently improved, and the Young's modulus cannot be suppressed to be sufficiently low. In addition, Mg is an active element. Therefore, in the case where an excessive amount of Mg is contained, there is a concern that Mg oxides which are generated by reactions with oxygen during melting and casting are mixed (contained). Accordingly, the content of Mg is more preferably set to be in a range of 3.7 at % to 6.3 at %.

Cr and Zr are elements having an effect of easily decreasing the size of crystal grains after an intermediate heat treatment. It is presumed that this is due to the fact that secondary-phase particles containing Cr and Zr are dispersed in a matrix phase and have an effect of suppressing the growth of crystal grains of the matrix phase during a heat treatment. This crystal grain refining effect is more remarkably exhibited by repeating the intermediate working and the intermediate heat treatment. In addition, due to the dispersion of such fine secondary-phase particles and the refinement of crystal grains, the strength is further improved without a great decrease in the conductivity.

Here, in the case where the content of Cr and the content of Zr are in a range of less than 0.001 at %, respectively, the effect cannot be exhibited. On the other hand, in the case where the content of Cr and the content of Zr are in a range of more than 0.15 at %, respectively, there is a concern that cracked edges are caused during rolling.

For these reasons, the content of Cr and the content of Zr are set to be in a range of 0.001 at % to 0.15 at %, respectively.

Furthermore, in the case where the content of Cr and the content of Zr are small, there is a concern that the effect of improving the strength and the effect of refining the crystal grains cannot be reliably exhibited. In addition, in the case where the content of Cr and the content of Zr are large, ease of rolling and bending workability are adversely affected.

Accordingly, the content of Cr and the content of Zr are more preferably set to be in a range of 0.005 at % to 0.12 at %, respectively.

Examples of the inevitable impurities include Sn, Zn, Al, Ni, Fe, Co, Ag, Mn, B, P, Ca, Sr, Ba, Sc, Y, rare-earth elements, Hf, V, Nb, Ta, Mo, W, Re, Ru, Os, Se, Te, Rh, Ir, Pd, Pt, Au, Cd, Ga, In, Li, Si, Ge, As, Sb, Ti, Tl, Pb, Bi, S, O, C, Be, N, H, and Hg. These inevitable impurities are preferably contained in a total amount of 0.3% by mass or less. Particularly, the content of Sn is preferably in a range of less than 0.1% by mass, and the content of Zn is preferably in a range of less than 0.01% by mass.

These are due to the following reasons. In the case where 0.1% by mass or more of Sn is added, intermetallic compounds containing Cu and Mg as main components easily precipitate. In addition, in the case where 0.01% by mass or more of Zn is added, fumes are generated in the melting and casting process and the fumes adhere to the furnace or a member of the mold; and thereby, the surface quality of the ingot deteriorates and the stress corrosion cracking resistance deteriorates.

### (Conductivity σ)

in the case where a conductivity σ (% IACS) satisfies the following Expression (2) when the content of Mg is represented by X at %, there are very few intermetallic compounds containing Cu and Mg as main components.

σ≦{1.7241/(−0.0347×X²+0.6569×X+1.7)}×100 (2)

That is, in the case where the conductivity σ is in a range of greater than the value on the right side of the above-described Expression (2), a large amount of intermetallic compounds containing Cu and Mg as main components are present, and furthermore, the sizes thereof are relatively large. Therefore, the bending workability greatly deteriorates. In addition, the intermetallic compounds containing Cu and Mg as main components are generated, and an amount of solid-solubilized Mg is small. Therefore, the Young's modulus is also increased. Therefore, production conditions are adjusted so that the conductivity σ satisfies the above-described Expression (2).

The intermetallic compounds containing Cu and Mg as main components have a crystal structure expressed by the chemical formula of MgCu₂, the prototype of MgCu₂, the Pearson symbol of cF24, and the space group number of Fd-3m.

In order to reliably exhibit the above-described effect, the conductivity σ (% IACS) preferably satisfies the following Expression (3).

σ≦{1.7241/(−0.0300×X²+0.6763×X+1.7)}×100 (3)

In this case, since intermetallic compounds containing Cu and Mg as main components are present in a smaller amount, the bending workability is further improved.

In order to more reliably exhibit the above-described effect, the conductivity σ (% IACS) more preferably satisfies the following Expression (4).

σ≦{1.7241/(−0.0292×X²+0.6797×X+1.7)}×100 (4)

In this case, since intermetallic compounds containing Cu and Mg as main components are present in a smaller amount, the bending workability is further improved.

### (Stress-Relaxation Rate)

In the copper alloy for electronic devices according to this embodiment, the stress-relaxation rate after 1,000 hours at 150° C. is in a range of 50% or less as described above.

In the case where the stress-relaxation rate under the foregoing conditions is low, permanent deformation can be suppressed to be at a low level even when the copper alloy is used under a high-temperature environment; and therefore, a decrease in the contact pressure can be suppressed. Therefore, the copper alloy for electronic devices according to this embodiment can be applied to a terminal which is used under a high-temperature environment such as the vicinity of an engine room of a vehicle.

The stress-relaxation rate is preferably in a range of 30% or less after 1,000 hours at 150° C., and more preferably in a range of 20% or less after 1,000 hours at 150° C.

### (Microstructure)

As a result of the observation by a scanning electron microscope, an average number of grains of intermetallic compounds containing Cu and Mg as main components which have a grain size of 0.1 μm or greater is in a range of 1/μm² or less in the copper alloy for electronic devices according to this exemplary embodiment. That is, intermetallic compounds containing Cu and Mg as main components rarely precipitate, and Mg is solid-solubilized in the matrix phase.

Here, in the case where the solution treatment is incomplete or the intermetallic compounds containing Cu and Mg as main components precipitate after the solution treatment, a large amount of intermetallic compounds containing Cu and Mg as main components and having a large size are present. In this case, these intermetallic compounds containing Cu and Mg as main components serve as a starting point of cracking. Therefore, cracking occurs during working or bending workability greatly deteriorates. In addition, it is not preferable that the amount of the intermetallic compounds containing Cu and Mg as main components be large, because the Young's modulus increases.

As a result of the examination of the microstructure, in the case where the number of grains of the intermetallic compounds containing Cu and Mg as main components and having grain sizes of 0.1 μm or greater is in a range of 1/μm² or less, that is, in the case where the intermetallic compounds containing Cu and Mg as main components are not present or the amount thereof is small, favorable bending workability and a low Young's modulus are obtained.

Furthermore, in order to reliably exhibit the above-described effects, the number of grains of the intermetallic compounds containing Cu and Mg as main components and having grain sizes of 0.05 μm or greater is more preferably in a range of 1/μm² or less.

The average number of grains of the intermetallic compounds containing Cu and Mg as main components is measured by the following method. 10 visual fields are observed using a field emission scanning electron microscope at 50,000-fold magnification under the condition in which the visual field is approximately 4.8 μm², and an average value of the number of grains in the visual fields is calculated.

In addition, an average value of the long diameter and the short diameter of a grain of the intermetallic compound is set as the grain size of the intermetallic compound containing Cu and Mg as main components. The long diameter is a length of the longest straight line in a grain which does not come into contact with a grain boundary on the way, and the short diameter is a length of the longest straight line in a direction orthogonal to the long diameter which does not come into contact with the grain boundary on the way.

### (Crystal Grain Size)

The crystal grain size is a factor which has a great influence on the stress relaxation resistance, and in the case where the crystal grain size is too small, the stress relaxation resistance deteriorates. In addition, in the case where the crystal grain size is too large, the bending workability is adversely affected. Therefore, the average crystal grain size is preferably in a range of 0.5 μm to 100 μm. The average crystal grain size is more preferably in a range of 0.7 μm to 50 μm, and even more preferably in a range of 0.7 μm to 30 μm.

In the case where a working rate of a finish working process S206 to be described later is high, the microstructure becomes a deformed structure, and the crystal grain size cannot be measured in some cases. Therefore, it preferable that the average crystal grain size be in the above-described range before the finish working process S206 (after an intermediate heat treatment process S205).

Here, in the case where the crystal grain size is in a range of greater than 10 μm, the average crystal grain size is preferably measured using an optical microscope. On the other hand, in the case where the crystal grain size is in a range of 10 μm or less, the average crystal grain size is preferably measured using a SEM-electron backscatter diffraction pattern (EBSD) measuring device.

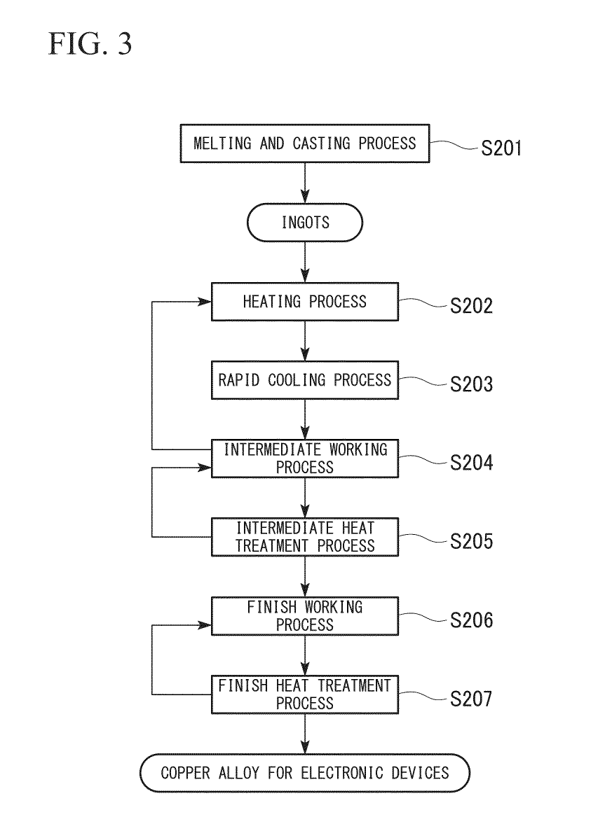

Next, a method for producing the copper alloy for electronic devices according to this embodiment will be described with reference to the flow diagram shown in FIG. 3.

In the following producing method, when rolling is used as a working process, the working rate corresponds to a rolling rate.

### (Melting and Casting Process S201)

First, a copper raw material is melted to obtain molten copper. Then, the above-described elements are added to the obtained molten copper so as to adjust components; and thereby, a molten copper alloy is produced. In the addition of Mg, a single element of Mg, a Cu—Mg master alloy, or the like can be used. In addition, a raw material containing Mg may be melted together with the copper raw material. In addition, a recycled material and a scrapped material of the copper alloy may be used.

Here, it is preferable that the molten copper be copper having a purity of 99.99% by mass or greater, i.e., so-called 4NCu. In addition, in the melting process, it is preferable to use a vacuum furnace, and more preferable to use an atmosphere furnace having an inert gas atmosphere or a reducing atmosphere so as to suppress oxidization of Mg.

The molten copper alloy in which the components are adjusted, is injected into a mold to produce copper alloy (copper material) ingots. A continuous casting method or a semi-continuous casting method is preferably used in consideration of mass production.

### (Heating Process S202)

Next, a heating treatment is performed for homogenization and solution treatment of the obtained ingots. In the course of solidification, Mg segregates and concentrates; and thereby, intermetallic compounds and the like containing Cu and Mg as main components are generated. In the interior of the ingots, these intermetallic compounds and the like containing Cu and Mg as main components are present. Therefore, in order to eliminate or reduce the segregation and the intermetallic compounds and the like, the ingots are subjected to a heating treatment to heat the ingots to a temperature of 400° C. to 900° C. Thereby, Mg is homogeneously diffused or Mg is solid-solubilized in a matrix phase in the ingots. It is preferable that the heating process S202 be performed in a non-oxidization atmosphere or a reducing atmosphere.

Here, in the case where the heating temperature is in a range of lower than 400° C., the solution treatment is incompletely performed; and thereby, there is a concern that a large amount of the intermetallic compounds containing Cu and Mg as main components is present in the matrix phase. On the other hand, in the case where the heating temperature is in a range of higher than 900° C., a part of the copper material becomes a liquid phase; and thereby, there is a concern that the microstructure or the surface state becomes uneven. Therefore, the heating temperature is set to be in a range of 400° C. to 900° C. The heating temperature is more preferably in a range of 500° C. to 850° C., and even more preferably in a range of 520° C. to 800° C.

### (Rapid Cooling Process S203)

Then, the copper material heated to a temperature of 400° C. to 900° C. in the heating process S202 is cooled to a temperature of 200° C. or lower at a cooling rate of 200° C./min or greater. Due to this rapid cooling process S203, the Mg solid-solubilized in the matrix phase is suppressed from being precipitated precipitating as intermetallic compounds containing Cu and Mg as main components. Therefore, the average number of grains of intermetallic compounds containing Cu and Mg as main components and having grain sizes of 0.1 μm or greater, which are observed by a scanning electron microscope, can be adjusted to be in a range of 1/μm² or less. That is, the copper material can be formed as a Cu—Mg supersaturated solid solution.

In order to increase the efficiency of rough working and the uniformity of the microstructure, hot working may be performed after the above-described heating process S202 and the above-described rapid cooling process S203 may be performed after this hot working. In this case, the working method (hot working method) is not particularly limited. For example, rolling can be employed in the case where the final form is a plate or a strip. Wire drawing, extrusion, groove rolling, or the like can be employed in the case where the final form is a line or a rod. Forging or pressing can be employed in the case where the final form is a bulk shape.

### (Intermediate Working Process S204)

The copper material subjected to the heating process S202 and the rapid cooling process S203 are cut as necessary. In addition, surface grinding is performed as necessary in order to remove an oxide film and the like generated by the heating process S202, the rapid cooling process S203, and the like. Then, the copper material is subjected to plastic working to have a predetermined shape.

A temperature condition in the intermediate working process S204 is not particularly limited, but it is preferable to set the working temperature to be in a range of −200° C. to 200° C. to perform cold or warm working. In addition, a working rate is appropriately selected so as to obtain a shape close to the final shape, but the working rate is preferably set to be in a range of 20% or greater in order to reduce the number of times of performing an intermediate heat treatment process S205 until the final shape is obtained. In addition, the working rate is more preferably set to be in a range of 30% or greater.

The plastic working method is not particularly limited. However, rolling is preferably employed in the case where the final shape is a plate or a strip. Extrusion or groove rolling is preferably employed in the case where the final shape is a line or a rod. Forging or pressing is preferably employed in the case where the final shape is a bulk shape. Furthermore, the processes S202 to S204 may be repeatedly performed for complete solution treatment.

### (Intermediate Heat Treatment Process S205)

After the intermediate working process S204, a heat treatment is performed so as to conduct complete solution treatment, to obtain a recrystallized microstructure, or to cause softening for improvement in workability.

The heat treatment method is not particularly limited, but it is preferable to perform the heat treatment under the condition in which a temperature is in a range of 400° C. to 900° C. in a non-oxidization atmosphere or a reducing atmosphere. The heat treatment temperature is more preferably in a range of 500° C. to 850° C., and even more preferably in a range of 520° C. to 800° C.

The intermediate working process S204 and the intermediate heat treatment process S205 may be repeatedly performed.

Here, in the intermediate heat treatment process S205, the copper material heated to a temperature of 400° C. to 900° C. is cooled to a temperature of 200° C. or lower at a cooling rate of 200° C./min or greater.

Due to such rapid cooling, the Mg solid-solubilized in the matrix phase is suppressed from being precipitated as intermetallic compounds containing Cu and Mg as main components. Thereby, the average number of grains of the intermetallic compounds containing Cu and Mg as main components and having grain sizes of 0.1 μm or greater in the observation by a scanning electron microscope can be adjusted to be in a range of 1/μm² or less. That is, the copper material can be formed as a Cu—Mg supersaturated solid solution.

### (Finish Working Process S206)

The copper material after the intermediate heat treatment process S205 is subjected to finish working to have a predetermined shape. In this finish working process S206, the temperature condition is not particularly limited, but the process is preferably performed at room temperature. In addition, a working rate is appropriately selected so as to obtain a shape close to the final shape. In order to improve a strength by work hardening, the working rate is preferably set to be in a range of 20% or greater. In addition, the working rate is more preferably set to be in a range of 30% or greater to further improve the strength. The plastic working method (finish working method) is not particularly limited. However, rolling is preferably employed in the case where the final shape is a plate or a strip. Extrusion or groove rolling is preferably employed in the case where the final shape is a line or a rod. Forging or pressing is preferably employed in the case where the final shape is a bulk shape.

### (Finish Heat Treatment Process S207)

Next, the worked material obtained by the finish working process S206 is subjected to a finish heat treatment so as to improve stress relaxation resistance and to cause hardening by low-temperature annealing, or to remove residual strains.

The heat treatment temperature is preferably set to be in a range of higher than 200° C. to 800° C. or lower. In this finish heat treatment process S207, it is necessary to set heat treatment conditions (temperature, time, and cooling rate) so that the solid-solubilized Mg does not precipitate. For example, this finish heat treatment process is preferably performed at 250° C. for approximately 10 seconds to 24 hours, at 300° C. for approximately 5 seconds to 4 hours, or at 500° C. for approximately 0.1 second to 60 minutes. It is preferable that this heat treatment be performed in a non-oxidization atmosphere or a reducing atmosphere.

In addition, it is preferable that water quenching be employed as a cooling method and the heated copper material be cooled to a temperature of 200° C. or lower at a cooling rate of 200° C./min or greater. Due to such rapid cooling, the Mg solid-solubilized in the matrix phase is suppressed from being precipitated as intermetallic compounds containing Cu and Mg as main components. Therefore, the average number of grains of intermetallic compounds containing Cu and Mg as main components and having grain sizes of 0.1 μm or greater, which are observed by a scanning electron microscope, can be adjusted to be in a range of 1/μm² or less. That is, the copper material can be formed as a Cu—Mg supersaturated solid solution.

Furthermore, the above-described finish working process S206 and the finish heat treatment process S207 may be repeatedly performed. The intermediate heat treatment process and the finish heat treatment process can be distinguished in accordance with whether the microstructure after plastic working in the intermediate working process or the finish working process is to be recrystallized or not.

In this manner, the copper alloy for electronic devices according to this embodiment is produced. The copper alloy for electronic devices according to this embodiment has a Young's modulus E of 125 GPa or less and a 0.2% proof stress σ_{0.2} of 400 MPa or greater.

In addition, when the content of Mg is represented by X at %, a conductivity σ (% IACS) satisfies the following Expression (2):

σ≦{1.7241/(−0.0347×X²+0.6569×X+1.7)}×100 (2)

Furthermore, due to the finish heat treatment process S207, the copper alloy for electronic devices according to this embodiment has a stress-relaxation rate of 50% or less after 1,000 hours at 150° C.

According to the copper alloy for electronic devices according to this embodiment, Mg is contained at a content of 3.3 at % to 6.9 at % which is not less than a solid solution limit, and one or more of Cr and Zr are contained at respective contents of 0.001 at % to 0.15 at %, and the balance is Cu and inevitable impurities. In addition, when the content of Mg is represented by X at %, a conductivity σ (% IACS) satisfies the following Expression (2):

σ≦{1.7241/(−0.0347×X²+0.6569×X+1.7)}×100 (2)

Furthermore, an average number of grains of intermetallic compounds containing Cu and Mg as main components and having grain sizes of 0.1 μm or greater, which are observed by a scanning electron microscope, is in a range of 1/μm² or less.

That is, the copper alloy for electronic devices according to this embodiment is a Cu—Mg supersaturated solid solution in which Mg is solid-solubilized in a matrix phase.

In the copper alloy including the Cu—Mg supersaturated solid solution, there is a tendency that the Young's modulus becomes low. For example, when the copper alloy is applied to a connector having a structure in which a male tab pushes up a spring contact portion of a female terminal and is inserted into the female terminal, a variation in contact pressure during the insertion is suppressed. In addition, since an elastic limit is high, there is no concern that plastic deformation easily occurs. Therefore, the copper alloy is particularly suitable for components for electronic devices such as terminals, connectors, relays, lead frames, and the like.

In addition, since Mg is solid-solubilized in a supersaturated manner, a large amount of coarse intermetallic compounds containing Cu and Mg as main components, which serve as a starting point of cracking, are not dispersed in a matrix phase; and thereby, the bending workability is improved. Therefore, it is possible to mold components for electronic devices having a complicated shape such as terminals, connectors, relays, lead frames, and the like.

Furthermore, since Mg is solid-solubilized in a supersaturated manner, the strength is improved by work hardening; and thereby, the copper alloy has a relatively high strength.

In addition, the copper alloy for electronic devices according to this embodiment contains either one or both of Cr and Zr at respective contents of 0.001 at % to 0.15 at %. Therefore, the size of crystal grains are decreased; and thereby, it is possible to improve a mechanical strength without greatly decreasing a conductivity.

In the copper alloy for electronic devices according to this embodiment, the stress-relaxation rate after 1,000 hours at 150° C. is in a range of 50% or less. Therefore, even during use under a high-temperature environment, it is possible to suppress the occurrence of energization failure due to a decrease in the contact pressure. Accordingly, the copper alloy for electronic devices can be applied as a material of a component for electronic devices which is used under a high-temperature environment such as an engine room.

In addition, since the copper alloy for electronic devices according to this embodiment has a Young's modulus of 125 GPa or less and a 0.2% proof stress σ_{0.2} of 400 MPa or greater, a resilience modulus (σ_{0.2}²/2E) is high; and therefore, plastic deformation does not easily occur. Accordingly, the copper alloy for electronic devices is particularly suitable for components for electronic devices such as terminals, connectors, relays, lead frames, and the like.

According to the method for producing the copper alloy for electronic devices according to this embodiment, the ingot or the worked material of a copper material having the above-described composition is heated to a temperature of 400° C. to 900° C. The solution treatment of Mg can be performed by the heating process S202.

In addition, in the rapid cooling process S203, the ingot or the worked material heated to a temperature of 400° C. to 900° C. by the heating process S202 is cooled to a temperature of 200° C. or lower at a cooling rate of 200° C./min or greater. Since this rapid cooling process S203 is provided, it is possible to suppress the precipitation of intermetallic compounds containing Cu and Mg as main components in the course of cooling. Accordingly, the ingot or the worked material after the rapid cooling can be formed as a Cu—Mg supersaturated solid solution.

Furthermore, since the intermediate working process S204 is provided to subject the rapidly cooled material (Cu—Mg supersaturated solid solution) to plastic working, a shape close to the final shape can be obtained.

In addition, after the intermediate working process S204, the intermediate heat treatment process S205 is provided so as to conduct complete solution treatment, to obtain a recrystallized microstructure, or to cause softening for improvement in workability. Therefore, it is possible to improve the characteristics and the workability.

In addition, in the intermediate heat treatment process S205, the copper material heated to a temperature of 400° C. to 900° C. is cooled to a temperature of 200° C. or lower at a cooling rate of 200° C./min or greater. Thereby, it is possible to suppress the precipitation of intermetallic compounds containing Cu and Mg as main components in the course of cooling, and the copper material after the rapid cooling can be formed as a Cu—Mg supersaturated solid solution.

In the method for producing the copper alloy for electronic devices according to this embodiment, the finish heat treatment process S207 is provided after the finish working process S206, and the finish working process S206 is for strength improvement by work hardening and for working into a predetermined shape. In this finish heat treatment process S207, a heat treatment is performed so as to improve the stress relaxation resistance and to cause hardening by low-temperature annealing, or to remove residual strains. Accordingly, the stress-relaxation rate after 1,000 hours at 150° C. can be adjusted to be in a range of 50% or less. In addition, it is possible to further improve the mechanical characteristics.

Here, the stress-relaxation rate is measured by applying a stress with the method according to the cantilever screw-type based on the Japan Copper and Brass Association Technical Standards JCBA-T309: 2004.

In addition, the copper alloy for electronic devices have a Young's modulus of 125 GPa or less and a 0.2% proof stress μ_{0.2} of 400 MPa or greater.

### (Plastically-Worked Copper Alloy Material for Electronic Devices)

A plastically-worked copper alloy material for electronic devices according to this embodiment includes the above-described copper alloy for electronic devices according to this embodiment. A Young's modulus E in a direction parallel to the rolling direction is in a range of 125 GPa or less, and a 0.2% proof stress σ_{0.2} in a direction parallel to the rolling direction is in a range of 400 MPa or greater. Since a resilience modulus (σ_{0.2}²/2E) is high, plastic deformation does not easily occur. Therefore, the plastically-worked copper alloy material is used as a copper material which constitutes components for electronic devices such as terminals, connectors, relays, lead frames, and the like. The plastic working method is not particularly limited. However, rolling is preferably employed in the case where the final shape is a plate or a strip. Extrusion or groove rolling is preferably employed in the case where the final shape is a line or a rod. Forging or pressing is preferably employed in the case where the final shape is a bulk shape.

### (Component for Electronic Devices)

A component for electronic devices according to this embodiment is formed of the above-described copper alloy for electronic devices according to this embodiment. Specific examples of the component include terminals, connectors, relays, lead frames, and the like. Since this component for electronic devices has a low Young's modulus and excellent stress relaxation resistance, it can be used even under a high-temperature environment.

The copper alloy for electronic devices, the method for producing the copper alloy for electronic devices, the plastically-worked copper alloy material for electronic devices, and the component for electronic devices according to the second embodiment of the invention have been described. However, the invention is not limited thereto, and it is possible to make appropriate changes without departing from the requirements of the invention.

For example, in the above-described embodiment, an example of the method for producing the copper alloy for electronic devices has been described, but the producing method is not limited to this embodiment, and a known producing method may be appropriately selected to produce the copper alloy.

### EXAMPLES

Hereinafter, a description will be made with respect to results of confirmation tests for confirming the effects of the embodiments.

### Example 1

A copper raw material consisting of oxygen-free copper (ASTM B152 C10100) having a purity of 99.99% by mass or more was prepared. This copper raw material was charged into a high-purity graphite crucible, and was high-frequency-melted in an atmosphere furnace having an Ar gas atmosphere to obtain molten copper. Various elements were added to the obtained molten copper so as to prepare component compositions shown in Tables 1 and 2, and each of the resultant materials was poured into a carbon mold to produce an ingot. The size of the ingot was set to have a thickness of approximately 20 mm, a width of approximately 30 mm, and a length of approximately 100 mm to 120 mm. In the compositions shown in Tables 1 and 2, the balance other than Mg, Cr, and Zr was Cu and inevitable impurities.

The obtained ingots were subjected to a heating process (homogenization/solution treatment) of performing heating in the Ar gas atmosphere for 4 hours under temperature conditions described in Tables 1 and 2, respectively, and then water quenching was performed.

The ingots after the heat treatment were cut and surface grinding was performed to remove oxide films.

Then, the resultant materials were subjected to intermediate rolling at room temperature at rolling rates described in Tables 1 and 2, respectively, to obtain strip materials. The obtained strip materials were subjected to an intermediate heat treatment under conditions described in Tables 1 and 2, respectively. The intermediate rolling and the intermediate heat treatment were repeatedly performed a number of times described in Tables 1 and 2, respectively. Furthermore, the resultant materials were subjected to finish rolling at finish rolling rates described in Tables 1 and 2, respectively, and finally, the resultant materials were subjected to a heat treatment under conditions described in

Tables 1 and 2, respectively. If necessary, surface grinding was performed in the course of the process to remove oxide films formed by the heat treatment. The strip materials were formed to have a final shape having a thickness of approximately 0.5 mm and a width of approximately 30 mm.

### (Evaluation of Workability)

The presence or absence of cracked edges was observed after the final finish rolling to evaluate workability. The copper alloys in which no cracked edges or little cracked edges were visually observed were evaluated as A (excellent), the copper alloys in which small cracked edges having lengths of less than 1 mm were caused were evaluated as B (good), the copper alloys in which cracked edges having lengths of 1 mm or more to less than 3 mm were caused were evaluated as C (fair), the copper alloys in which large cracked edges having lengths of 3 mm or greater were caused were evaluated as D (bad), and the copper alloys which were fractured due to cracked edges in the course of rolling were evaluated as E (very bad).

The length of the cracked edge refers to a length of the cracked edge from the end portion in the width direction toward the center portion in the width direction of the rolled material.

Mechanical characteristics and a conductivity were measured using the above-described strip materials for characteristic evaluation.

### (Mechanical Characteristics)

A test piece No. 13B defined in JIS Z 2201 was taken from the strip material for characteristic evaluation. This test piece was taken so that the tensile direction in a tensile test was in parallel with the rolling direction of the strip material for characteristic evaluation.

A 0.2% proof stress σ_{0.2} was measured by the offset method specified in JIS Z 2241. A strain gauge was attached to the above-described test piece to measure a load and an elongation. From a gradient of a stress-strain curve obtained from the measured load and the elongation, a Young's modulus E was obtained.

### (Conductivity)

A test piece having a width of 10 mm and a length of 60 mm was taken from the strip material for characteristic evaluation. This test piece was taken so that the longitudinal direction thereof was in parallel with the rolling direction of the strip material for characteristic evaluation.

An electrical resistance of the test piece was obtained by a four-terminal method. In addition, dimensions of the test piece were measured using a micrometer to calculate a volume of the test piece. Then, a conductivity was calculated from the electrical resistance value and the volume which were measured.

### (Bending Workability)

Bending work was performed according to the test method 4 of the Japan Copper and Brass Association Technical Standards JCBA-T307: 2007.

A plurality of test pieces having a width of 10 mm and a length of 30 mm were taken from the strip materials for characteristic evaluation so that the rolling direction was perpendicular to the longitudinal direction of the test piece. Next, a W bending test was performed using a W-type jig having a bending angle of 90 degrees and a bending radius of 0.5 mm.

An outer peripheral portion of the bent portion was visually confirmed. The copper alloys in which it was not possible to confirm a fracture or fine cracking were evaluated as A (Excellent), the copper alloys in which only fine cracking occurred without fracture were evaluated as B (Good), the copper alloys in which only a part thereof was fractured were evaluated as C (Fair), and the copper alloys which were fractured were evaluated as D (Bad).

### (Observation of Microstructure)

A rolled surface of each sample was subjected to mirror polishing and ion etching. The observation was performed at magnifications of 10,000 to 100,000 by using a field emission scanning electron microscope (FE-SEM) in order to confirm a precipitation state of intermetallic compounds containing Cr and Zr. The case in which the precipitation of intermetallic compounds containing Cr and Zr was confirmed was denoted by “∘”. It was not possible to observe the microstructure in Comparative Examples 1-2, 1-3, 1-5, and 1-6.

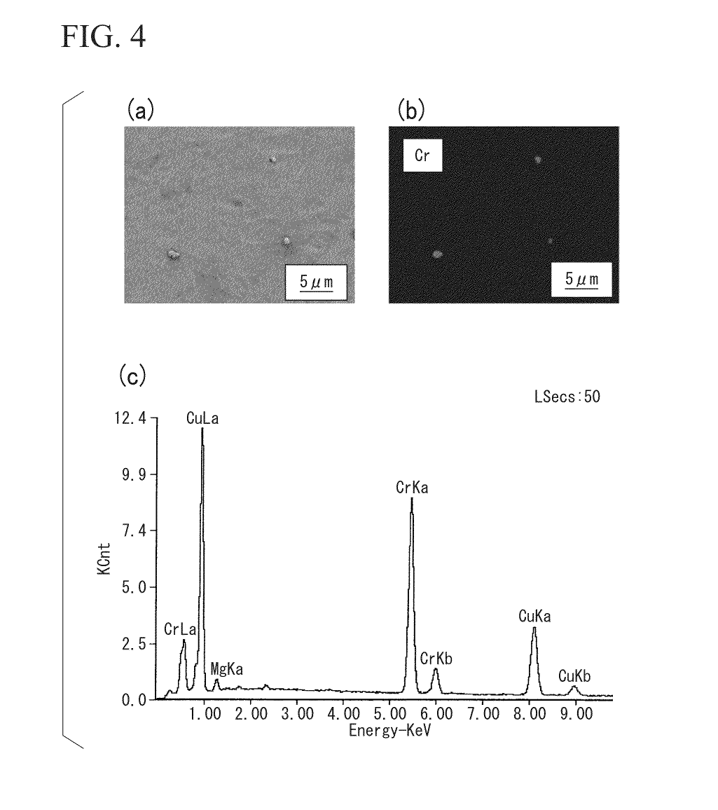

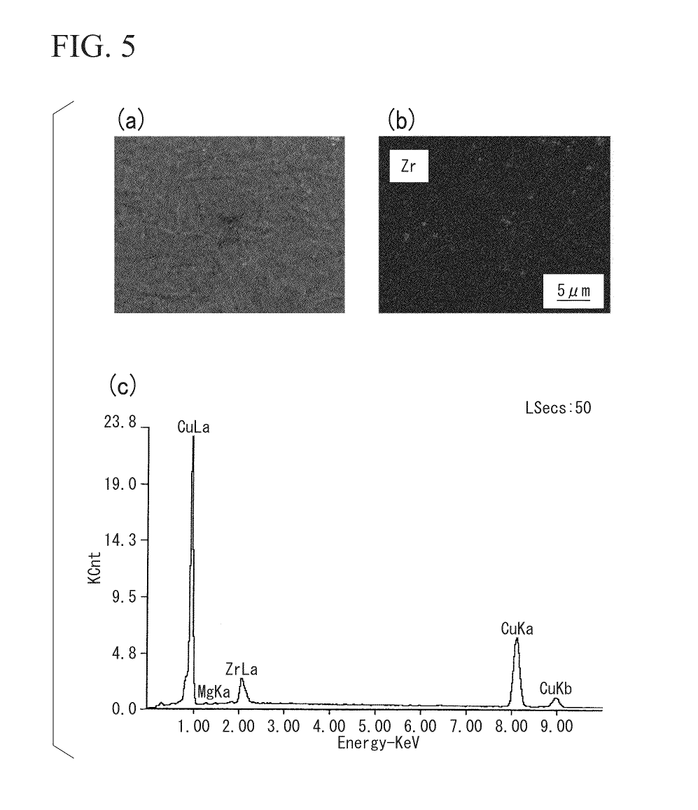

In addition, the strip materials for characteristic evaluation of Invention Examples 1-3 and 1-10 were observed at approximately 40,000-fold magnification. Furthermore, components of the precipitates were confirmed using energy dispersion X-ray spectrometry (EDX). The observation results are shown in FIGS. 4 and 5.

### (Measurement of Crystal Grain Size)

Each sample was subjected to mirror polishing and etching, and was photographed by an optical microscope so that the rolling direction met the horizontal direction of the photograph; and thereby, the observation was performed in a visual field (approximately 300 μm×200 μm) at 1,000-fold magnification. Next, a crystal grain size was measured according to the cutting method specified in JIS H 0501. In the photograph, five vertical line segments and five longitudinal line segments having a predetermined length were drawn, and the number of crystal grains completely cut was counted. An average value of the cut lengths was used as an average crystal grain size.

The production conditions and the evaluation results are shown in Tables 1 to 4.

TABLE 1

| | | | | | | | | | Number of | | | |
|---|---|---|---|---|---|---|---|---|---|---|---|---|
| | | | | | | | | | Times of | | | |
| | | | | | | | | | Repeatedly | | | |
| | | | | | | | | | Performing | | | |
| | | | | | | | | | Steps from | | | |
| | | | | | | | | | Intermediate | | | |
| | | | | | | | | | Rolling to d | | | |
| | | | | | | | Intermediate Heat | | Intermediate | Finish | | |
| | | Mg | Cr | Zr | Homogenization/ | Intermediate | Treatment | | Heat | Rolling | Heat Treatment | |
| | | (at %) | (at %) | (at %) | Solution treatment | Rolling Rate | Temperature | Time | Treatment | Rate | Temperature | Time |
| Invention | 1-1 | 3.4 | 0.10 | — | 715° C. | 60% | 600° C. | 1 min | 1 | 50% | 200° C. | 1 h |
| Examples | 1-2 | 4.9 | 0.002 | — | 715° C. | 60% | 600° C. | 1 min | 1 | 50% | 200° C. | 1 h |
| | 1-3 | 5.0 | 0.09 | — | 715° C. | 60% | 600° C. | 1 min | 1 | 50% | 200° C. | 1 h |
| | 1-4 | 5.0 | 0.09 | — | 715° C. | 60% | 600° C. | 1 min | 2 | 50% | 200° C. | 1 h |
| | 1-5 | 5.0 | 0.09 | — | 715° C. | 60% | 600° C. | 1 min | 3 | 50% | 200° C. | 1 h |
| | 1-6 | 5.0 | 0.14 | — | 715° C. | 60% | 600° C. | 1 min | 1 | 50% | 200° C. | 1 h |
| | 1-7 | 6.4 | 0.11 | — | 715° C. | 60% | 700° C. | 1 min | 1 | 50% | 200° C. | 1 h |
| | 1-8 | 3.3 | — | 0.02 | 715° C. | 60% | 600° C. | 1 min | 1 | 50% | 200° C. | 1 h |
| | 1-9 | 4.9 | — | 0.002 | 715° C. | 60% | 600° C. | 1 min | 1 | 50% | 200° C. | 1 h |
| | 1-10 | 4.9 | — | 0.02 | 715° C. | 60% | 600° C. | 1 min | 1 | 50% | 200° C. | 1 h |
| | 1-11 | 4.9 | — | 0.02 | 715° C. | 60% | 600° C. | 1 min | 2 | 50% | 200° C. | 1 h |
| | 1-12 | 4.9 | — | 0.02 | 715° C. | 60% | 600° C. | 1 min | 3 | 50% | 200° C. | 1 h |
| | 1-13 | 5.0 | — | 0.14 | 715° C. | 60% | 600° C. | 1 min | 1 | 50% | 200° C. | 1 h |
| | 1-14 | 6.3 | — | 0.05 | 715° C. | 60% | 700° C. | 1 min | 1 | 50% | 200° C. | 1 h |
| | 1-15 | 4.8 | 0.10 | 0.05 | 715° C. | 60% | 600° C. | 1 min | 1 | 50% | 200° C. | 1 h |
| | 1-16 | 4.4 | 0.10 | 0.05 | 715° C. | 60% | 600° C. | 1 min | 1 | 30% | 200° C. | 1 h |
| | 1-17 | 4.4 | 0.10 | 0.05 | 715° C. | 60% | 600° C. | 1 min | 1 | 50% | 200° C. | 1 h |
| | 1-18 | 4.4 | 0.10 | 0.05 | 715° C. | 60% | 600° C. | 1 min | 1 | 70% | 200° C. | 1 h |

TABLE 2

| | | | | | | | | | Number of | | | |
|---|---|---|---|---|---|---|---|---|---|---|---|---|
| | | | | | | | | | Times of | | | |
| | | | | | | | | | Repeatedly | | | |
| | | | | | | | | | Performing | | | |
| | | | | | | | | | Steps from | | | |
| | | | | | | | | | Intermediate | | | |
| | | | | | Homo- | | | | Rolling to | | | |
| | | | | | genization/ | | Intermediate Heat | | Intermediate | Finish | | |
| | | Mg | Cr | Zr | Solution | Intermediate | Treatment | | Heat | Rolling | Heat Treatment | |
| | | (at %) | (at %) | (at %) | treatment | Rolling Rate | Temperature | Time | Treatment | Rate | Temperature | Time |
| Comparative | 1-1 | 2.1 | 0.09 | — | 715° C. | 60% | 600° C. | 1 min | 1 | 50% | 200 | 1 h |
| Examples | 1-2 | 7.8 | 0.11 | — | 715° C. | 60% | 700° C. | 1 min | 1 | 50% | — | — |
| | 1-3 | 2.0 | 0.32 | — | 715° C. | 60% | 600° C. | 1 min | 1 | 50% | — | — |
| | 1-4 | 1.9 | — | 0.02 | 715° C. | 60% | 600° C. | 1 min | 1 | 50% | 200 | 1 h |
| | 1-5 | 7.9 | — | 0.03 | 715° C. | 60% | 600° C. | 1 min | 1 | 50% | — | — |
| | 1-6 | 4.9 | — | 0.31 | 715° C. | 60% | 600° C. | 1 min | 1 | 50% | — | — |
| | 1-7 | 4.9 | 0.06 | — | 715° C. | 60% | 600° C. | 1 min | 1 | 75% | 400 | 0.5 h |
| | 1-8 | 4.9 | 0.10 | 0.05 | 715° C. | 60% | 600° C. | 1 min | 1 | 50% | 450 | 2 h |
| | 1-9 | 4.0 | 0.05 | — | 715° C. | 60% | 600° C. | 1 min | 1 | 50% | 400 | 2 h |
| | 1-10 | 6.2 | 0.10 | — | 715° C. | 60% | 700° C. | 1 min | 1 | 50% | 400 | 2 h |

| | | | | | | | | |
|---|---|---|---|---|---|---|---|---|
| Conventional | 3.0Ni—1.6Si—0.5Zn—0.3Sn | 980° C. | — | — | — | 40% | 400 | 4 h |
| Example 1-1 | | | | | | | | |

TABLE 3

| | | | | Upper Limit of | | Average | | | |
|---|---|---|---|---|---|---|---|---|---|
| | | | | Conductivity | Presence or | Crystal | Proof | Young's | |
| | | Cracked | | (value on the right | Absence of | Grain Size | Strength | Modulus | Bending |
| | | Edges | Conductivity | side of Expression (1)) | Precipitates | (μm) | (MPa) | (GPa) | Workability |
| Invention | 1-1 | A | 45% | 49% | ∘ | 15.0 | 530 | 119 | A |
| Examples | 1-2 | A | 36% | 42% | ∘ | 16.2 | 590 | 114 | B |
| | 1-3 | B | 36% | 42% | ∘ | 12.3 | 616 | 113 | B |
| | 1-4 | B | 37% | 42% | ∘ | 5.2 | 636 | 112 | B |
| | 1-5 | B | 36% | 42% | ∘ | 5.0 | 656 | 113 | B |
| | 1-6 | B | 35% | 42% | ∘ | 5.1 | 630 | 112 | B |
| | 1-7 | C | 32% | 38% | ∘ | 15.0 | 650 | 110 | C |
| | 1-8 | B | 45% | 49% | ∘ | 12.5 | 532 | 118 | B |
| | 1-9 | B | 36% | 42% | ∘ | 15.3 | 591 | 115 | B |
| | 1-10 | B | 37% | 42% | ∘ | 10.3 | 650 | 114 | B |
| | 1-11 | B | 37% | 42% | ∘ | 4.6 | 670 | 113 | B |
| | 1-12 | B | 37% | 42% | ∘ | 4.0 | 679 | 112 | B |
| | 1-13 | B | 35% | 42% | ∘ | 4.5 | 695 | 112 | C |
| | 1-14 | B | 33% | 39% | ∘ | 12.0 | 681 | 110 | C |
| | 1-15 | B | 35% | 43% | ∘ | 4.0 | 685 | 113 | C |
| | 1-16 | A | 39% | 44% | ∘ | 5.6 | 520 | 114 | B |
| | 1-17 | A | 39% | 44% | ∘ | 5.6 | 655 | 114 | B |
| | 1-18 | A | 38% | 44% | ∘ | 5.6 | 699 | 113 | C |

TABLE 4

| | | | | Upper Limit of | | Average | | | |
|---|---|---|---|---|---|---|---|---|---|
| | | | | Conductivity | Presence or | Crystal | Proof | Young's | |
| | | Cracked | | (value on the right | Absence of | Grain Size | Strength | Modulus | Bending |
| | | Edges | Conductivity | side of Expression (1)) | Precipitates | (μm) | (MPa) | (GPa) | Workability |
| Comparative | 1-1 | A | 58% | 59% | ∘ | 18.0 | 478 | 126 | A |
| Examples | 1-2 | E | — | 37% | — | — | — | — | — |
| | 1-3 | D | — | 60% | — | — | — | — | — |
| | 1-4 | A | 58% | 61% | ∘ | 15.3 | 489 | 127 | A |
| | 1-5 | E | — | 36% | — | — | — | — | — |
| | 1-6 | D | — | 42% | — | — | — | — | — |
| | 1-7 | B | 44% | 42% | ∘ | 13.0 | 580 | 120 | D |
| | 1-8 | B | 47% | 42% | ∘ | 5.7 | 475 | 115 | D |
| | 1-9 | B | 51% | 46% | ∘ | 12.7 | 493 | 118 | D |
| | 1-10 | B | 48% | 39% | ∘ | 15.3 | 580 | 115 | D |

| | | | | | | | | |
|---|---|---|---|---|---|---|---|---|
| Conventional | A | 31% | — | ∘ | — | 610 | 131 | B |
| Example 1-1 | | | | | | | | |

In Comparative Examples 1-1 and 1-4, the contents of Mg were lower than the range of the present embodiment, and high Young's moduli, i.e., in a range of 126 GPa and 127 GPa were exhibited, respectively.

In Comparative Examples 1-2 and 1-5, the contents of Mg were higher than the range of the present embodiment, and large cracked edges were caused during cold rolling; and thereby, a fracture occurred in the course of rolling. Therefore, it was not possible to perform the subsequent characteristic evaluation.

In Comparative Example 1-3, the content of Cr was higher than the range of the present embodiment, and in Comparative Example 1-6, the content of Zr was higher than the range of the present embodiment. In Comparative Examples 1-3 and 1-6, no fracture occurred during cold rolling, but large cracked edges were caused during cold rolling. Therefore, it was not possible to perform the subsequent characteristic evaluation.

In Comparative Examples 1-7, 1-8, 1-9, and 1-10, the contents of Mg, Cr, and Zr were in the ranges of the present embodiment, respectively, but the conductivity did not satisfy the Expression (1) of the present embodiment. In these Comparative Examples 1-7, 1-8, 1-9, and 1-10, a deterioration in bending workability was confirmed. It is presumed that this is due to the fact that coarse intermetallic compounds containing Cu and Mg as main components served as a starting point of cracking.

In Conventional Example 1-1 which was a copper alloy called as Corson alloy containing Ni, Si, Zn, and Sn, a temperature of a heating process for solution treatment was set to 980° C., and the heat treatment conditions were set to be 400° C. for 4 h so as to precipitate intermetallic compounds. In this Conventional Example 1-1, the occurrence of cracked edges was suppressed and the formed precipitates were fine; and as a result, the bending workability was secured. However, it was confirmed that the Young's modulus was high, i.e., 131 GPa.

On the other hand, in all of Invention Examples 1-1 to 1-18, the Young's moduli were set to be low, i.e., in a range of 119 GPa or less, and elasticity was excellent. In addition, Invention Examples 1-3 to 1-5 had the same composition, but were different from each other in terms of the number of times of repeatedly performing the intermediate rolling and the intermediate heat treatment; and therefore, Invention Examples 1-3 to 1-5 had different total working rates. Similarly, Invention Examples 1-10 to 1-12 also had the same composition, but were different from each other in terms of the number of times of repeatedly performing the intermediate rolling and the intermediate heat treatment; and therefore, Invention Examples 1-10 to 1-12 had different total working rates. When comparing Invention Examples 1-3 to 1-5 and Invention Examples 1-10 to 1-12, it was confirmed that it was possible to improve the 0.2% proof stress by repeatedly performing the intermediate rolling and the intermediate heat treatment. In Invention Example 1-7, the cracked edge evaluation result was C, but this level has no problems in practical use. In addition, in Invention Examples 1-7, 1-13 to 1-15, and 1-18, the bending workability evaluation result was C, but it is confirmed that this level also has no problems in practical use.

In addition, as shown in FIG. 4, in Invention Example 1-3 containing Cr, granular precipitates of Cr were confirmed, but coarse precipitates containing Mg were not observed. In addition, as shown in FIG. 5, in Invention Example 1-10 containing Zr, granular precipitates of Zr and Cu were confirmed, but coarse precipitates containing Mg were not observed.

From the foregoing description, according to the invention examples of Example 1, it was confirmed that it was possible to provide a copper alloy for electronic devices which has a low Young's modulus, a high proof stress, high electrical conductivity, and excellent bending workability, and is suitable for electronic/electrical components such as terminals, connectors, relays, and the like.

### Example 2

A copper raw material consisting of oxygen-free copper (ASTM B152 C10100) having a purity of 99.99% by mass or more was prepared. This copper raw material was charged into a high-purity graphite crucible, and was high-frequency-melted in an atmosphere furnace having an Ar gas atmosphere to obtain molten copper. Various elements were added to the obtained molten copper so as to prepare component compositions shown in Tables 5 and 6, and each of the resultant materials was poured into a carbon mold to produce an ingot. The size of the ingot was set to have a thickness of approximately 20 mm, a width of approximately 20 mm, and a length of approximately 100 mm to 120 mm.

The obtained ingots were subjected to a heating process of performing heating in the Ar gas atmosphere for 4 hours at temperatures described in Tables 5 and 6, respectively, and then water quenching was performed.

The ingots after the heat treatment were cut and surface-ground to remove oxide films.

Then, the resultant materials were subjected to intermediate rolling at room temperature at rolling rates described in Tables 5 and 6, respectively, to obtain strip materials. The obtained strip materials were subjected to an intermediate heat treatment in a salt bath at temperatures described in Tables 5 and 6, respectively. Thereafter, water quenching was performed.

Next, the resultant materials were subjected to finish rolling at rolling rates shown in Tables 5 and 6, respectively; and thereby, strip materials having a thickness of 0.25 mm and a width of approximately 20 mm were produced.

After the finish rolling, the strip materials were subjected to a finish heat treatment in a salt bath under conditions shown in Tables 5 and 6, and then water quenching was performed. In this manner, strip materials for characteristic evaluation were produced.

### (Crystal Grain Size After Intermediate Heat Treatment)

Crystal grain sizes were measured in the samples after the intermediate heat treatment shown in Tables 5 and 6. Each sample was subjected to mirror polishing and etching, and its rolled surface was photographed by an optical microscope to perform the observation in a visual field (approximately 300 μm×200 μm) at 1,000-fold magnification. Next, a crystal grain size was measured according to the cutting method specified in JIS H 0501. In the photograph, five vertical line segments and five longitudinal line segments having a predetermined length were drawn, and the number of crystal grains completely cut was counted. An average value of the cut lengths was used as an average crystal grain size.

In addition, in the case where the average crystal grain size was in a range of 10 μm or less, the average crystal grain size was measured using a SEM-electron backscatter diffraction pattern (EBSD) measuring device with the following method. Mechanical polishing was performed using a waterproof abrasive paper or diamond abrasive grains. Next, finish polishing was performed using a colloidal silica solution. Then, electron beams were irradiated on respective measurement points (pixels) in a measurement range of a sample surface by using a scanning electron microscope. Orientation analysis was conducted by backscattered electron beam diffraction, and the grain boundary between measurement points in which the difference in the orientation between the measurement points next to each other was in a range of 15° or greater was defined as a high-angle grain boundary, and the grain boundary between measurement points in which the difference in the orientation between the measurement points next to each other was in a range of 15° or less was defined as a low-angle grain boundary. A crystal grain boundary map was made using the high-angle grain boundary. With respect to the crystal grain boundary map, five vertical line segments and five longitudinal line segments having a predetermined length were drawn according to the cutting method specified in JIS H 0501, and the number of crystal grains completely cut was counted. An average value of the cut lengths was used as an average crystal grain size.

### (Evaluation of Workability)

The presence or absence of cracked edges during the above-described cold rolling was observed to evaluate workability. The copper alloys in which no cracked edge or little cracked edges were visually observed were evaluated as A (excellent), the copper alloys in which small cracked edges having lengths of less than 1 mm were caused were evaluated as B (good), the copper alloys in which cracked edges having lengths of 1 mm or more to less than 3 mm were caused were evaluated as C (fair), the copper alloys in which large cracked edges having lengths of 3 mm or greater were caused were evaluated as D (bad), and the copper alloys which were fractured due to cracked edges in the course of rolling were evaluated as E (very bad).

The length of the cracked edge refers to a length of the cracked edge from the end portion in the width direction toward the center portion in the width direction of the strip material for characteristic evaluation.

Mechanical characteristics and a conductivity were measured using the above-described strip materials for characteristic evaluation.

### (Mechanical Characteristics)

A test piece No. 1313 defined in JIS Z 2201 was taken from the strip material for characteristic evaluation. This test piece was taken so that the tensile direction in a tensile test was in parallel with the rolling direction of the strip material for characteristic evaluation.

A 0.2% proof stress σ_{0.2} was measured by the offset method specified in JIS Z 2241. A strain gauge was attached to the above-described test piece to measure a load and an elongation. From a gradient of a load-elongation curve obtained from the measured load and elongation, a Young's modulus E was obtained.

### (Conductivity)

A test piece having a width of 10 mm and a length of 60 mm was taken from the strip material for characteristic evaluation. This test piece was taken so that the longitudinal direction thereof was in parallel with the rolling direction of the strip material for characteristic evaluation.

An electrical resistance of the test piece was obtained by a four-terminal method. In addition, dimensions of the test piece were measured using a micrometer to calculate a volume of the test piece. Then, a conductivity was calculated from the electrical resistance value and the volume which were measured.

### (Stress Relaxation Resistance)

A test piece (width: 10 mm) was taken so that the longitudinal direction thereof was in parallel with the rolling direction of the strip material for characteristic evaluation.

The stress relaxation resistance test was performed by the method according to the cantilever screw-type based on the Japan Copper and Brass Association Technical Standards JCBA-T309: 2004. A stress was applied in accordance with the method according to the cantilever screw-type, and the test piece was held for a predetermined time at a temperature of 150° C. Thereafter, a residual stress rate was measured.

An initial deflection displacement was set to 2 mm and a span length was adjusted so that the maximum surface stress of the test piece was 80% of the proof stress. The maximum surface stress is determined by the following method.

Maximum Surface Stress (MPa)=1.5Etδ₀/L_{S}²

E, t, δ₀, and L_{S} are as follows.

E: deflection coefficient (MPa)

t: thickness of sample (t=0.25 mm)

δ₀: initial deflection coefficient

L_{S}: span length (mm)

The residual stress rate was measured from the bending habit after holding for 1,000 hours at a temperature of 150° C., and the stress-relaxation rate was evaluated. The stress-relaxation rate was calculated using the following expression.

Stress-Relaxation Rate (%)=(δₜ/δ₀)×100

δₜ and δ₀ are as follows.

δₜ: (permanent deflection displacement (mm) after holding for 1,000 hours at 150° C.)—(permanent deflection displacement (mm) after holding for 24 hours at room temperature)

δ₀: initial deflection displacement (mm)

### (Observation of Microstructure)

A rolled surface of each sample was subjected to mirror polishing and ion etching. The observation was performed in a visual field (approximately 120 μm²/visual field) at 10,000-fold magnification by using a field emission scanning electron microscope (FE-SEM) in order to confirm a precipitation state of intermetallic compounds containing Cu and Mg as main components.

Next, in order to examine a density (the number of grains/μm²) of the intermetallic compounds containing Cu and Mg as main components, a visual field (approximately 120 μm²/visual field) at 10,000-fold magnification in which the precipitation state of the intermetallic compound was not specific was selected, and in this area, continuous 10 visual fields (approximately 4.8 μm²/visual field) were photographed at 50,000-fold magnification. An average value of the long diameter and the short diameter of a grain of the intermetallic compound was set as a grain size of the intermetallic compounds. The long diameter is a length of the longest straight line in a grain which does not come into contact with a grain boundary on the way, and the short diameter is a length of the longest straight line in a direction orthogonal to the long diameter which does not come into contact with the grain boundary on the way. The density (average number) (the number of grains/μm²) of the intermetallic compounds containing Cu and Mg as main components and having grain sizes of 0.1 μm or greater was obtained.

### (Bending Workability)

Bending work was performed according to the test method 4 of the Japan Copper and Brass Association Technical Standards JCBA-T307: 2007.

A plurality of test pieces having a width of 10 mm and a length of 30 mm were taken from the strip materials for characteristic evaluation so that the rolling direction was in parallel with the longitudinal direction of the test piece. Next, a W bending test was performed using a W-type jig having a bending angle of 90 degrees and a bending radius of 0.25 mm.

An outer peripheral portion of the bent portion was visually confirmed. The copper alloys in which it was not possible to confirm a fracture or fine cracking were evaluated as A (Excellent), the copper alloys in which only fine cracking occurred without fracture were evaluated as B (Good), the copper alloys in which only a part thereof was fractured were evaluated as C (Fair), and the copper alloys which were fractured were evaluated as D (Bad).

The production conditions and the evaluation results are shown in Tables 5 to 8.

TABLE 5

| | | | | | | | Intermediate | Intermediate | Finish | | | |
|---|---|---|---|---|---|---|---|---|---|---|---|---|
| | | Component Composition | | | | Heating | Rolling | Heat | Rolling | Finish Heat | | |
| | | Mg | Cr | Zr | | Process | Rolling | Treatment | Rolling | Treatment | | |
| | | (at %) | (at %) | (at %) | Cu | Temperature | Rate | Temperature | Rate | Temperature | Time | |
| Invention | 2-1 | 3.4 | 0.08 | — | Balance | 715° C. | 70% | 625° C. | 60% | 230° C. | 60 | min |
| Examples | 2-2 | 4.2 | 0.06 | 0.03 | Balance | 715° C. | 70% | 550° C. | 60% | 250° C. | 30 | min |
| | 2-3 | 4.2 | 0.10 | — | Balance | 715° C. | 80% | 550° C. | 50% | 300° C. | 1 | min |
| | 2-4 | 4.4 | 0.04 | 0.08 | Balance | 715° C. | 70% | 625° C. | 60% | 310° C. | 1 | min |
| | 2-5 | 5.1 | 0.06 | — | Balance | 715° C. | 70% | 625° C. | 60% | 330° C. | 1 | min |
| | 2-6 | 5.3 | 0.06 | 0.05 | Balance | 715° C. | 70% | 650° C. | 60% | 370° C. | 30 | sec |
| | 2-7 | 5.8 | — | 0.03 | Balance | 715° C. | 70% | 650° C. | 60% | 350° C. | 1 | min |
| | 2-8 | 6.3 | — | 0.14 | Balance | 715° C. | 70% | 700° C. | 60% | 290° C. | 5 | min |
| | 2-9 | 4.3 | 0.05 | 0.01 | Balance | 715° C. | 70% | 625° C. | 70% | 210° C. | 30 | sec |
| | 2-10 | 4.3 | 0.05 | — | Balance | 715° C. | 70% | 625° C. | 70% | 320° C. | 1 | min |
| | 2-11 | 4.5 | 0.05 | — | Balance | 715° C. | 70% | 625° C. | 70% | 510° C. | 1 | sec |
| | 2-12 | 4.3 | — | 0.10 | Balance | 715° C. | 50% | 500° C. | 60% | 230° C. | 1 | sec |
| | 2-13 | 4.2 | — | 0.10 | Balance | 715° C. | 50% | 525° C. | 60% | 210° C. | 50 | sec |

TABLE 6

| | | Component Composition | | | | Heating | Intermediate | Intermediate | Finish | Finish Heat | |
|---|---|---|---|---|---|---|---|---|---|---|---|
| | | Mg | Cr | Zr | | Process | Rolling | Heat Treatment | Rolling | Treatment | |
| | | (at %) | (at %) | (at %) | Cu | Temperature | Rolling Rate | Temperature | Rolling Rate | Temperature | Time |
| Comparative | 2-1 | 0.9 | 0.05 | — | Balance | 715° C. | 70% | 600° C. | 60% | 300° C. | 1 min |
| Examples | 2-2 | 2.0 | — | 0.05 | Balance | 715° C. | 70% | 600° C. | 60% | 270° C. | 1 min |
| | 2-3 | 7.9 | 0.08 | — | Balance | 715° C. | 70% | — | — | — | — |
| | 2-4 | 10.3 | — | 0.05 | Balance | 715° C. | 70% | — | — | — | — |
| | 2-5 | 4.3 | — | 0.04 | Balance | 715° C. | 70% | 625° C. | 60% | — | — |
| | 2-6 | 4.7 | 0.01 | — | Balance | 715° C. | 70% | 625° C. | 60% | 410° C. | 1 h |
| | 2-7 | 6.3 | — | 0.25 | Balance | 715° C. | 70% | — | — | — | — |
| | 2-8 | 6.5 | 0.55 | — | Balance | 715° C. | 70% | — | — | — | — |

| | | Component Composition | | | Heating | Intermediate | | Finish | Finish Heat | |
|---|---|---|---|---|---|---|---|---|---|---|
| | | Sn | | | Process | Rolling | Intermediate Heat | Rolling | Treatment | |
| | | (at %) | P (at %) | Cu | Temperature | Rolling Rate | Treatment Temperature | Rolling Rate | Temperature | Time |
| Conventional | 2-1 | 3.2 | 0.3 | Balance | 800° C. | 70% | 500° C. | 70% | 270° C. | 1 min |
| Examples | 2-2 | 4.5 | 0.3 | Balance | 800° C. | 70% | 500° C. | 70% | 240° C. | 1 min |

TABLE 7

| | | Average Crystal | | | Upper Limit of | | | | | |
|---|---|---|---|---|---|---|---|---|---|---|
| | | Grain Size After | | | Conductivity | | 0.2% | | | |
| | | Intermediate | | | (value on the | Precipitates | Proof | Stress- | Young's | |
| | | Heat Treatment | Cracked | Conductivity | right side of | (number of | Stress | Relaxation | Modulus | Bending |
| | | (μm) | Edges | (% IACS) | Expression (2)) | grains/μm²) | (MPa) | Rate | (GPa) | Workability |
| Invention Examples | 2-1 | 8 | A | 44.1% | 48.7% | 0 | 551 | 24% | 116 | A |
| | 2-2 | 0.8 | A | 41.2% | 44.9% | 0 | 661 | 30% | 113 | A |
| | 2-3 | 1.3 | A | 40.7% | 44.8% | 0 | 645 | 27% | 111 | A |
| | 2-4 | 5 | A | 38.4% | 43.9% | 0 | 627 | 20% | 112 | A |
| | 2-5 | 10 | A | 34.8% | 41.7% | 0 | 647 | 18% | 109 | A |
| | 2-6 | 8 | A | 33.2% | 41.0% | 0 | 657 | 18% | 109 | A |
| | 2-7 | 11 | B | 33.1% | 39.7% | 0 | 664 | 19% | 108 | B |
| | 2-8 | 3 | B | 30.9% | 38.6% | 0 | 687 | 25% | 105 | B |
| | 2-9 | 15 | A | 37.8% | 44.4% | 0 | 668 | 33% | 112 | A |
| | 2-10 | 14 | A | 38.8% | 44.6% | 0 | 634 | 17% | 111 | A |
| | 2-11 | 14 | A | 39.2% | 43.5% | 0 | 639 | 20% | 111 | A |
| | 2-12 | 3 | B | 43.5% | 44.6% | 0 | 614 | 48% | 110 | B |
| | 2-13 | 4 | A | 43.0% | 45.0% | 0 | 614 | 43% | 108 | A |

TABLE 8

| | | | | | Upper Limit of | | | | | |
|---|---|---|---|---|---|---|---|---|---|---|
| | | Average Crystal Grain | | | Conductivity | | 0.2% | | | |
| | | Size After Intermediate | | | (value on the | Precipitates | Proof | Stress- | Young's | |
| | | Heat Treatment | Cracked | Conductivity | right side | (number of | Stress | Relaxation | Modulus | Bending |
| | | (μm) | Edges | (% IACS) | of Expression (2)) | grains/μm²) | (MPa) | Rate | (GPa) | Workability |
| Comparative | 2-1 | 10 | A | 73.1% | 76.6% | 0 | 398 | 26% | 127 | A |
| Examples | 2-2 | 12 | A | 58.8% | 60.5% | 0 | 512 | 24% | 128 | A |
| | 2-3 | — | E | — | — | — | — | — | — | — |
| | 2-4 | — | E | — | — | — | — | — | — | — |
| | 2-5 | 11 | A | 37.8% | 44.3% | 0 | 649 | 54% | 112 | A |
| | 2-6 | 14 | A | 47.8% | 42.9% | 10 | 389 | 25% | 119 | D |
| | 2-7 | — | D | — | — | — | — | — | — | — |
| | 2-8 | — | E | — | — | — | — | — | — | — |
| Conventional | 2-1 | 10 | B | 14.2% | — | — | 713 | 54% | 110 | A |
| Examples | 2-2 | 8 | B | 12.8% | — | — | 774 | 52% | 109 | A |

In Comparative Examples 2-1 and 2-2, the contents of Mg were lower than the range of the present embodiment, the 0.2% proof stresses were low, and relatively high Young's moduli, i.e., in a range of 127 GPa and 128 GPa were exhibited, respectively.

In Comparative Examples 2-3 and 2-4, the contents of Mg were higher than the range of the present embodiment, and large cracked edges were caused during intermediate rolling. Therefore, it was not possible to perform the subsequent characteristic evaluation.

Comparative Example 2-5 had a composition within the range of the present embodiment, but was not subjected to a final heat treatment (finish heat treatment) after finish rolling. In this Comparative Example 2-5, the stress-relaxation rate was 54%.

Comparative Example 2-6 had a composition within the range of the present embodiment, but the conductivity did not satisfy the Expression (2) of the present embodiment. In addition, the number of grains of intermetallic compounds containing Cu and Mg as main components was out of the range of the present embodiment. In this

Comparative Example 2-6, it was confirmed that the proof stress was low. In addition, in Comparative Example 2-6, it was confirmed that the bending workability deteriorated.

In Comparative Examples 2-7 and 2-8, the contents of Cr and Zr were higher than the ranges of the present embodiment, and cracked edges were caused during intermediate rolling. Therefore, it was not possible to perform the subsequent characteristic evaluation.

Furthermore, in Conventional Examples 2-1 and 2-2 which were copper alloys called as phosphor bronze containing Sn and P, the conductivities were low and the stress-relaxation rates were in a range of greater than 50%.

On the other hand, in all of Invention Examples 2-1 to 2-13, the Young's moduli were low, i.e., in a range of 116 GPa or less, the 0.2% proof stresses were in a range of 550 MPa or greater, and elasticity was excellent. In addition, the stress-relaxation rates were also low, i.e., in a range of 48% or less. Furthermore, the crystal grain sizes after the intermediate heat treatment were in a range of 15 μm or less; and therefore, the crystal grain sizes were decreased by the addition of Cr and Zr.

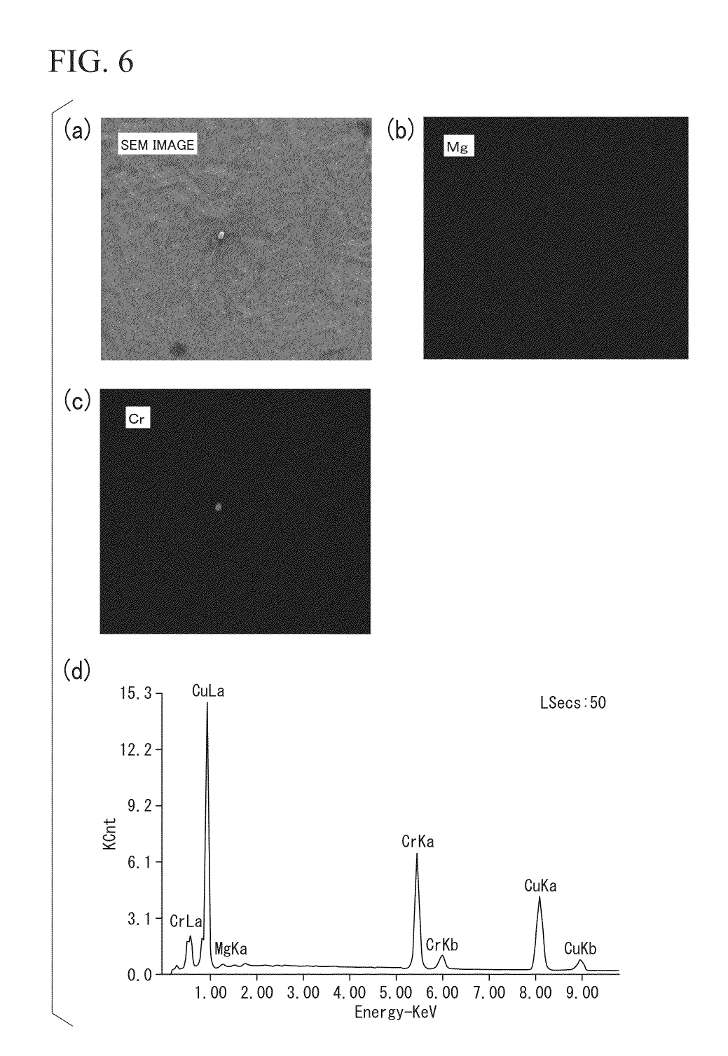

Here, as shown in FIG. 6, in Invention Example 2-3 containing Cr, granular precipitates of Cr were confirmed, but intermetallic compounds containing Cu and Mg as main components were not observed.

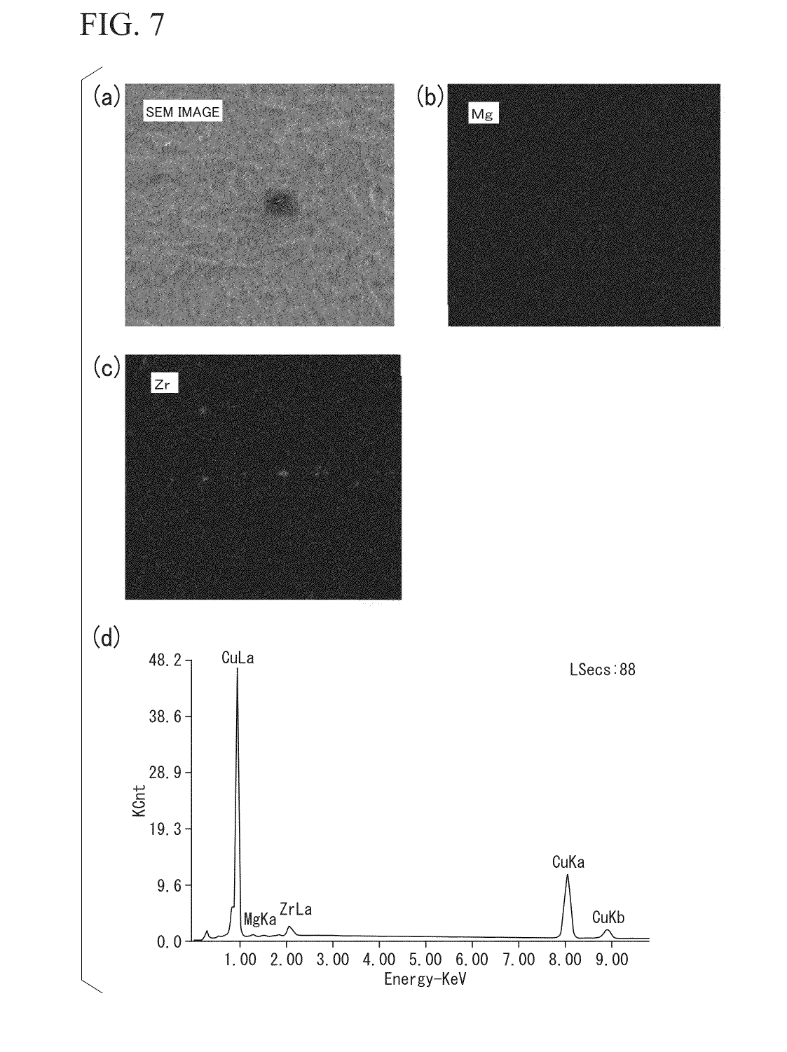

In addition, as shown in FIG. 7, in Invention Example 2-8 containing Zr, granular precipitates containing Zr were confirmed, but intermetallic compounds containing Cu and Mg as main components were not observed.

From the foregoing description, according to the invention examples of Example 2, it was confirmed that it was possible to provide a copper alloy for electronic devices which has a low Young's modulus, a high proof stress, high electrical conductivity, excellent stress relaxation resistance, and excellent bending workability, and is suitable for components for electronic devices such as terminals, connectors, relays, and the like.

### INDUSTRIAL APPLICABILITY

The copper alloy for electronic devices according to an aspect of the invention has a low Young's modulus, a high proof stress, high electrical conductivity, and excellent bending workability. Therefore, this copper alloy for electronic devices can be preferably applied to components for electronic devices such as terminals, connectors, relays, and the like.

The copper alloy for electronic devices according to another aspect of the invention has a low Young's modulus, a high proof stress, high electrical conductivity, excellent stress relaxation resistance, and excellent bending workability. Therefore, this copper alloy can be preferably applied to components for electronic devices such as terminals, connectors, relays, lead frames, and the like. Particularly, due to its excellent stress relaxation resistance, this copper alloy for electronic devices can be preferably applied to components for electronic devices which are used under a high-temperature environment such as an engine room and the like.

### BRIEF DESCRIPTION OF REFERENCE SIGNS

S102: HEATING PROCESS

S103: RAPID COOLING PROCESS

S104: WORKING PROCESS

S206: FINISH WORKING PROCESS

S207: FINISH HEAT TREATMENT PROCESS

1. A copper alloy for electronic devices, comprising: Mg at a content of 3.3 at % or more to less than 6.9 at %; and either one or both of Cr and Zr at respective contents of 0.001 at % to 0.15 at %, with the balance being Cu and inevitable impurities,
wherein when the content of Mg is represented by A at %, a conductivity σ (% IACS) satisfies the following Expression (1):
σ≦{1.7241/(−0.0347×A²+0.6569×A+1.7)}×100 (1).

2. The copper alloy for electronic devices according to claim 1,
wherein a Young's modulus E is in a range of 125 GPa or less, and a 0.2% proof stress σ_{0.2} is in a range of 400 MPa or greater.

3. The copper alloy for electronic devices according to claim 1,
wherein an average crystal grain size is in a range of 20 μm or less.

4. A method for producing a copper alloy for electronic devices, the method comprising:
heating a copper material that comprises: Mg at a content of 3.3 at % or more to less than 6.9 at %; and either one or both of Cr and Zr at respective contents of 0.001 at % to 0.15 at %, with the balance being Cu and inevitable impurities, to a temperature of 300° C. to 900° C.;
rapidly cooling the heated copper material to a temperature of 200° C. or lower at a cooling rate of 200° C./min or greater; and
subjecting the rapidly cooled copper material to working,
wherein the copper alloy for electronic devices according to claim 1 is produced.

5. A plastically-worked copper alloy material for electronic devices, comprising the copper alloy for electronic devices according to claim 1,
wherein a Young's modulus E in a rolling direction is in a range of 125 GPa or less, and a 0.2% proof stress σ_{0.2} in the rolling direction is in a range of 400 MPa or greater.

6. The plastically-worked copper alloy material for electronic devices according to claim 5, which is used as a copper material constituting a terminal, a connector, or a relay.

7. A copper alloy for electronic devices, comprising: Mg at a content of 3.3 at % to 6.9 at %; and either one or both of Cr and Zr at respective contents of 0.001 at % to 0.15 at %, with the balance being substantially Cu and inevitable impurities,
wherein when the content of Mg is represented by X at %, a conductivity σ (% IACS) satisfies the following Expression (2), and
a stress-relaxation rate after 1,000 hours at 150° C. is in a range of 50% or less,
σ≦{1.7241/(−0.0347×X²+0.6569×X+1.7)}×100 (2).

8. A copper alloy for electronic devices, comprising: Mg at a content of 3.3 at % to 6.9 at %; and either one or both of Cr and Zr at respective contents of 0.001 at % to 0.15 at %, with the balance being substantially Cu and inevitable impurities,
wherein an average number of grains of intermetallic compounds containing Cu and Mg as main components and having grain sizes of 0.1 μm or greater, which are observed by a scanning electron microscope, is in a range of 1/μm² or less, and
a stress-relaxation rate after 1,000 hours at 150° C. is in a range of 50% or less.

9. A copper alloy for electronic devices, comprising: Mg at a content of 3.3 at % to 6.9 at %; and either one or both of Cr and Zr at respective contents of 0.001 at % to 0.15 at %, with the balance being substantially Cu and inevitable impurities,
wherein when the content of Mg is represented by X at %, a conductivity σ (% IACS) satisfies the following Expression (2),
an average number of grains of intermetallic compounds containing Cu and Mg as main components and having grain sizes of 0.1 μm or greater, which are observed by a scanning electron microscope, is in a range of 1/μm² or less, and
a stress-relaxation rate after 1,000 hours at 150° C. is in a range of 50% or less,
σ≦{1.7241/(−0.0347×X²+0.6569×X+1.7)}×100 (2).

10. The copper alloy for electronic devices according to claim 7,
wherein a Young's modulus is in a range of 125 GPa or less, and a 0.2% proof stress σ_{0.2} is in a range of 400 MPa or greater.

11. A method for producing a copper alloy for electronic devices, the method comprising:
subjecting a copper material having a composition that comprises: Mg at a content of 3.3 at % to 6.9 at %; and either one or both of Cr and Zr at respective contents of 0.001 at % to 0.15 at %, with the balance being substantially Cu and inevitable impurities, to finish rolling to roll the copper material into a predetermined shape; and
performing a finish heat treatment to perform a heat treatment after the finish rolling,
wherein the copper alloy for electronic devices according to claim 7 is produced.

12. The method for producing a copper alloy for electronic devices according to claim 11,
wherein in the finish heat treatment, the heat treatment is performed at a temperature in a range of higher than 200° C. to 800° C. or lower, and
then, the heated copper material is cooled to a temperature of 200° C. or lower at a cooling rate of 200° C./min or greater.

13. A plastically-worked copper alloy material for electronic devices, comprising the copper alloy for electronic devices according to claim 7,
wherein a Young's modulus E in a direction parallel to a rolling direction is in a range of 125 GPa or less, and a 0.2% proof stress σ_{0.2} in the direction parallel to the rolling direction is in a range of 400 MPa or greater.

14. A plastically-worked copper alloy material for electronic devices, comprising the copper alloy for electronic devices according to claim 7,
wherein the plastically-worked copper alloy material is used as a copper material constituting a component for electronic devices which is a terminal, a connector, a relay or a lead frame.

15. A component for electronic devices, which is formed of the copper alloy for electronic devices according to claim 7.

16. The copper alloy for electronic devices according to claim 2,
wherein an average crystal grain size is in a range of 20 μm or less.

17. A method for producing a copper alloy for electronic devices, the method comprising:
heating a copper material that comprises: Mg at a content of 3.3 at % or more to less than 6.9 at %; and either one or both of Cr and Zr at respective contents of 0.001 at % to 0.15 at %, with the balance being Cu and inevitable impurities, to a temperature of 300° C. to 900° C.;
rapidly cooling the heated copper material to a temperature of 200° C. or lower at a cooling rate of 200° C./min or greater; and
subjecting the rapidly cooled copper material to working,
wherein the copper alloy for electronic devices according to claim 2 is produced.

18. A plastically-worked copper alloy material for electronic devices, comprising the copper alloy for electronic devices according to claim 2,
wherein a Young's modulus E in a rolling direction is in a range of 125 GPa or less, and a 0.2% proof stress σ_{0.2} in the rolling direction is in a range of 400 MPa or greater.

19. A method for producing a copper alloy for electronic devices, the method comprising:
subjecting a copper material having a composition that comprises: Mg at a content of 3.3 at % to 6.9 at %; and either one or both of Cr and Zr at respective contents of 0.001 at % to 0.15 at %, with the balance being substantially Cu and inevitable impurities, to finish rolling to roll the copper material into a predetermined shape; and
performing a finish heat treatment to perform a heat treatment after the finish rolling,
wherein the copper alloy for electronic devices according to claim 8 is produced.

20. A plastically-worked copper alloy material for electronic devices, comprising the copper alloy for electronic devices according to claim 8,
wherein a Young's modulus E in a direction parallel to a rolling direction is in a range of 125 GPa or less, and a 0.2% proof stress σ_{0.2} in the direction parallel to the rolling direction is in a range of 400 MPa or greater.
